(19) United States
(12) Patent Application Publication
(10) Pub. No.: US 2026/0049020 A1
(43) Pub. Date: Feb. 19, 2026

(54) HOLLOW-CORE OPTICAL FIBERS AND METHODS FOR PRODUCING THE SAME

(71) Applicant: CORNING INCORPORATED, Corning, NY (US)

(72) Inventor: Pushkar Tandon, Painted Post, NY (US)

(21) Appl. No.: 19/283,382

(22) Filed: Jul. 29, 2025

Related U.S. Application Data
(60) Provisional application No. 63/683,586, filed on Aug. 15, 2024.

(51) Int. Cl. C03B 15/14

(52) U.S. Cl. CPC C03B 15/14; C03B 2203/16; C03B 2205/12; C03B 2205/60

(57) ABSTRACT

A method includes heating a hollow-core preform comprising an outer tube and an inner tube. The outer tube includes an inner radius r_{ocp} and an outer radius R_{ocp}. The inner tube includes an inner radius r_{cp} and an outer radius R_{cp}. The method further includes drawing a hollow-core optical fiber from the hollow-core preform at a draw tension T_{g} in grams, thereby elongating the outer tube into an outer cladding of the hollow-core optical fiber and the inner tube to a capillary of the hollow-core optical fiber. The draw tension T_{g} and/or a differential capillary pressure Δp_{c} are selected at least in part based on a non-dimensional parameter

$${X}_{1} = \frac{3 π ( {R}_{ocp}^{2} - {r}_{ocp}^{2} ) {R}_{cp} ( Δ {p}_{c} {r}_{cp} - 2 {σ}_{c} )}{4 {Tr}_{cp} ( {R}_{cp} - {r}_{cp} )} ,$$

where T is the draw tension in dynes and T=981×T_{g}, Δp_{c} is in dynes/cm², σ_{c} in dyne/cm is a surface energy of a glass material forming the inner tube, and −0.5≤X₁≤0.75.

This application claims the benefit of priority under 35 U.S.C. § 119 of U.S. Provisional Application Ser. No. 63/683,586 filed on Aug. 15, 2024, the content of which is relied upon and incorporated herein by reference in its entirety.

### FIELD

The present disclosure generally relates to methods for producing optical fibers, and more specifically, to methods for producing hollow-core optical fibers.

### BACKGROUND

Hollow-core optical fibers are a new class of fibers that are attractive because of their optical properties of low loss, low attenuation, low latency, ultralow non-linearity, low flat dispersion, ultra broadband transmission, radiation hardness, and negligible Rayleigh backscattering. However, hollow-core optical fibers also suffer from the need for high precision of fiber microstructures. A typical design of an anti-resonant hollow core optical fiber may include an outer cladding along with two or more non-touching capillaries (or nested capillaries) attached on the inner surface of the outer cladding to define the hollow core through which the light is propagated. The propagation characteristics of the hollow-core optical fibers, such as anti-resonant optical fibers, are strongly related to the microstructures and dimensions thereof for effective guiding by the waveguide.

Hollow-core optical fibers can be produced by drawing a hollow-core preform into fiber. During the manufacture of the anti-resonant hollow-core optical fiber, especially when the starting preform sizes are increased for continuously drawing longer lengths of the fiber, the relative dimensions of the outer cladding and the capillaries may not be preserved from the preform to the fiber during the drawing of the fiber. Accordingly, it is important to understand the change in dimensions of the different components of the fiber during the draw process for scaling up and manufacturability.

### SUMMARY

Described herein are methods and processes addressing challenges in scaling up of the hollow-core optical fiber drawing process to large-volume manufacturing. The inventor has recognized that the degree of change in microstructure from the preform to the fiber may be impacted by the size of the preform and/or the size of the draw hot zone. The inventor further recognizes that the surface tension and/or pressure forces inside the outer cladding tube during the draw process may also affect the dimensions of the outer cladding and the capillaries of the fiber drawn. Accordingly, the inventor has developed methods and processes for achieving targe fiber microstructure dimensions with high precision, including but not limited to determining the process conditions for attaining desired microstructures in the hollow-core optical fiber from hollow-core preform of different sizes during scaleup, which are all significant for scaleup and realizing low-cost large volume manufacturing of anti-resonant optical fibers.

In some embodiments, a method of producing a hollow-core optical fiber from a hollow-core preform, may include heating a hollow-core preform including an outer tube and an inner tube. The outer tube may include an inner surface defining an interior cavity and an inner radius r_{ocp} and an outer surface defining an outer radius R_{ocp}. The inner tube may include an inner surface defining an interior cavity and an inner radius r_{cp} and an outer surface defining an outer radius R_{cp}. The inner tube may be formed from a glass material. The method may further include drawing a hollow-core optical fiber from the hollow-core preform at a draw tension T_{g} in grams, thereby elongating the outer tube of the hollow-core preform into an outer cladding of the hollow-core optical fiber and elongating the inner tube of the hollow-core preform into a capillary of the hollow-core optical fiber. The draw tension T_{g} and a differential capillary pressure Δp_{c} may be selected at least in part based on a non-dimensional parameter X₁. The differential capillary pressure Δp_{c} is defined as a difference between a pressure inside the interior cavity of the inner tube of the hollow-core preform and a pressure inside the interior cavity of the outer tube of the hollow-core preform. X₁ is defined as

$${X}_{1} = \frac{3 π ( {R}_{ocp}^{2} - {r}_{ocp}^{2} ) {R}_{cp} ( Δ {p}_{c} {r}_{cp} - 2 {σ}_{c} )}{4 {Tr}_{cp} ( {R}_{cp} - {r}_{cp} )} ,$$

where T is the draw tension in dynes, and T=981×T_{g}, Δp_{c} is in dynes/cm², and σ_{c} in dyne/cm is a surface energy of the glass material forming the inner tube. In some embodiments, X₁ may be greater than or equal to −0.5 and less than or equal to 0.75.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figured.

FIGS. 1A and 1B schematically depict cross-sectional views of exemplary hollow-core optical fibers.

FIGS. 2A and 2B schematically depict cross-sectional views of exemplary hollow-core preforms for drawing the hollow-core optical fibers of FIG. 1A and FIG. 1B, respectively.

FIG. 3 schematically depicts an exemplary drawing system.

FIG. 4 schematically illustrates an implementation of a finite-analytic solution of evolution of preform outer tube inner and outer radii.

FIG. 5 is a plot showing inner diameters of capillaries drawn as a function of differential capillary pressures during the drawing process for exemplary preform dimensions and operating conditions.

FIG. 6 is another plot showing inner diameters of capillaries drawn as a function of differential capillary pressures during the drawing process for further exemplary preform dimensions and operating conditions.

FIG. 7 is another plot showing inner diameters of capillaries drawn as a function of differential capillary pressures during the drawing process for further exemplary preform dimensions and operating conditions.

FIG. 8 is another plot showing inner diameters of capillaries drawn as a function of differential capillary pressures during the drawing process for further exemplary preform dimensions and operating conditions.

FIG. 9 is a plot showing the evolution of inner diameters of capillaries from inner tubes of exemplary hollow-core preforms in the neck down region as a function of axial velocity in the neck down region, for different combinations of preform sizes, draw speeds, and differential capillary pressures.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “≥” are used interchangeably, and “less than” and “≤” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g. frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Hollow-Core Optical Fiber

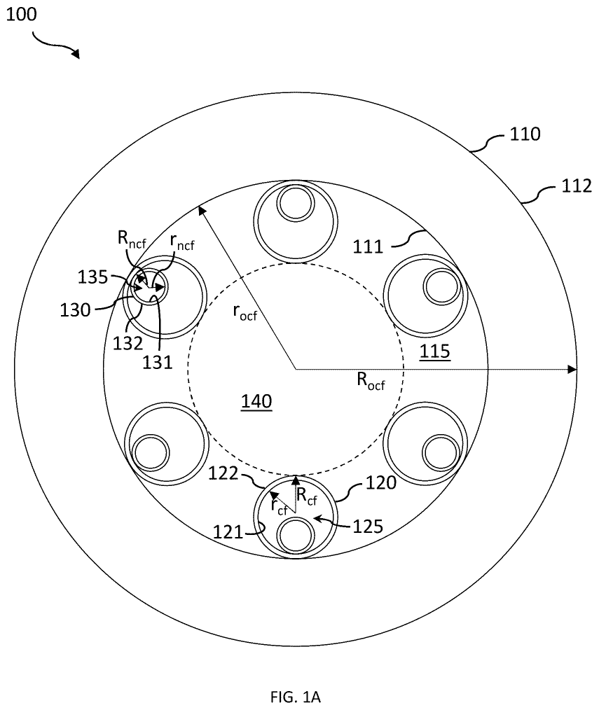

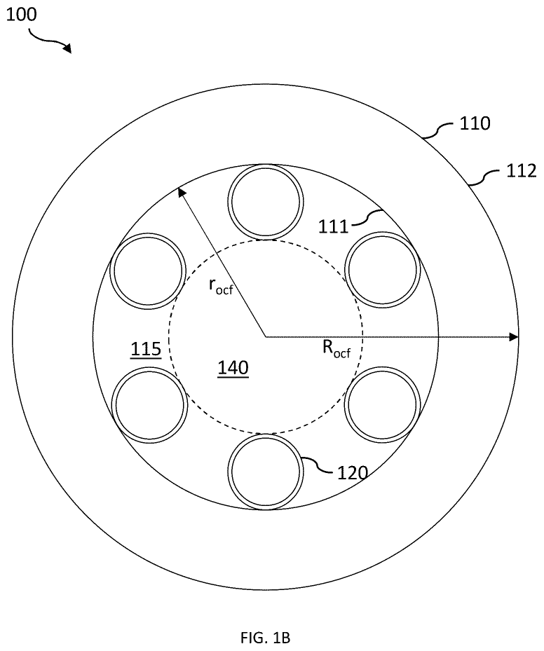

FIG. 1A schematically illustrates an example of a hollow-core optical fiber 100. The hollow-core optical fiber 100 may include an outer cladding 110. The outer cladding 110 may include an inner surface 111 defining an interior cavity 115 and an inner radius r_{ocf} of the outer cladding 110, and an outer surface 112 defining an outer radius R_{ocf} of the outer cladding 110.

The hollow-core optical fiber 100 may further include two or more (e.g., two, three, four, five, six, or more) cladding elements, such as capillaries 120, inside the interior cavity 115 of the outer cladding 110. The capillaries 120 may be in contact with and/or attached to the inner surface 111 of the outer cladding 110. The capillaries 120 may not be in contact with each other and may be evenly spaced along the inner surface 111 of the outer cladding 110. Each of the capillaries 120 may include an inner surface 121 defining an interior cavity 125 and an inner radius r_{c}f of each of the capillaries 120, and an outer surface 122 defining an outer radius Rₑf of each of the capillaries 120.

In some embodiments, the cladding elements of the hollow-core optical fiber 100 may also include nested capillaries 130 with each disposed inside a capillary 120 and in contact with and/or attached to an inner surface of the capillary 120. Each of the nested capillaries 130 may include an inner surface 131 defining an interior cavity 135 and an inner radius r_{acf} of each of the nested capillaries 130, and an outer surface 132 defining an outer radius R_{ncf} of each of the nested capillaries 130. In some embodiments, the hollow-core optical fiber 100 may not include nested capillaries 130, such as shown in FIG. 1B.

The cladding elements of the hollow-core optical fiber 100, e.g., the capillaries 120 and/or the nested capillaries 130, may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. In some embodiments, the outer cladding 110, the capillaries 120, and/or the nested capillaries 130 may include silica glass and/or silica-based glass (i.e., silica glass comprising one or more dopants).

### Hollow-Core Preform

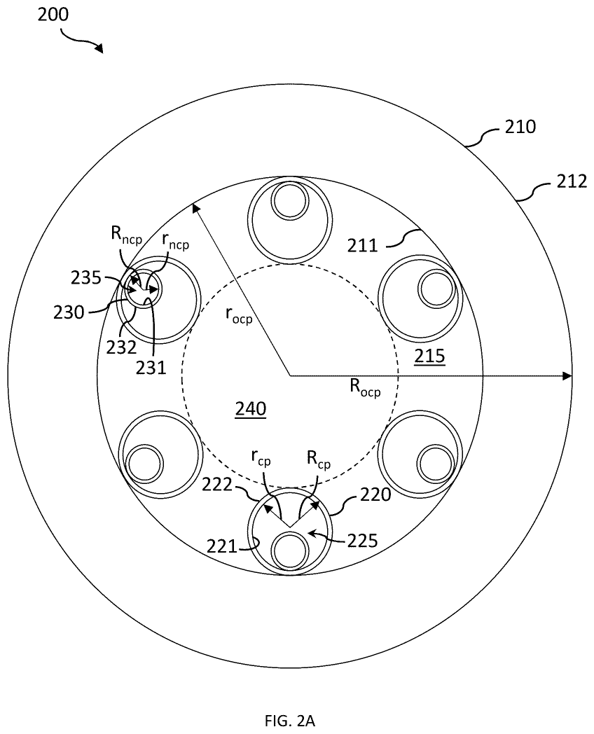

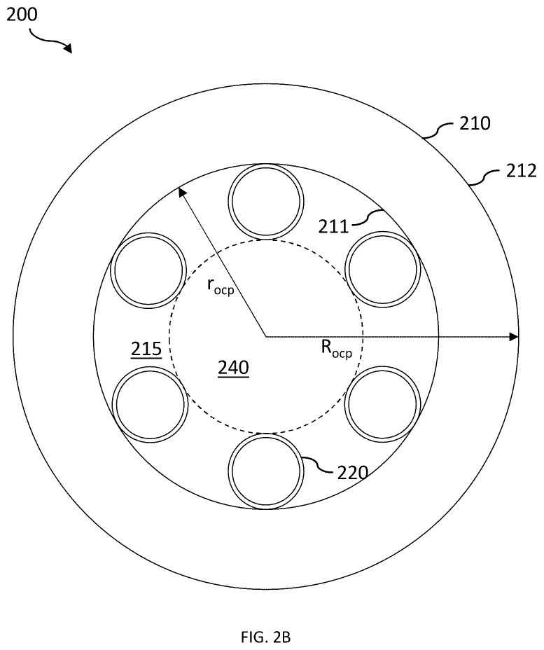

The hollow-core optical fiber 100 may be produced by drawing a hollow-core preform into fiber. FIGS. 2A and 2B schematically illustrate non-limiting examples of hollow-core preform 200 that may be utilized for producing the hollow-core optical fiber 100 shown in FIGS. 1A and 1B, respectively. In some embodiments, the hollow-core preform 200 may include an outer tube 210. The outer tube 210 may be drawn into the outer cladding 110 of the hollow-core optical fiber 100. The outer tube 210 may include an inner surface 211 defining an interior cavity 215 and an inner radius r_{ocp} of the outer tube 210, and an outer surface 212 defining an outer radius R_{ocp} of the outer tube 210.

In some embodiments, the hollow-core preform 200 may further include two or more (e.g., two, three, four, five, six, or more) inner tubes 220 inside the interior cavity 215 of the outer tube 210. In some embodiments, the inner tubes 220 may be in contact with and/or attached to the inner surface 211 of the outer tube 210. In some embodiments, the inner tubes 220 may not be in contact with each other and may be evenly spaced along the inner surface 211 of the outer tube 210. Each of the inner tubes 220 may be drawn into a capillary 120 of the hollow-core optical fiber 100. Each of the inner tubes 220 may include an inner surface 221 defining an interior cavity 225 and an inner radius r_{cp} of each of the inner tubes 220, and an outer surface 222 defining an outer radius R_{cp} of each of the inner tubes 220.

In some embodiments, such as shown in FIG. 2A, the hollow-core preform 200 may also include two or more nested tubes 230 with each disposed inside an inner tube 220 and in contact with and/or attached to an inner surface of the inner tube 220. Each of the nested tubes 230 may be drawn into a nested capillary 130 of the hollow-core optical fiber 100. Each of the nested tubes 230 may include an inner surface 231 defining an interior cavity 235 and an inner radius r_{ncp} of each of the nested tubes 230, and an outer surface 232 defining an outer radius R_{ncp} of each of the nested tubes 230. In some embodiments, the hollow-core preform 200 may not include nested tubes 230, such as shown in FIG. 2B.

The inner tubes 220 may surround and define a hollow section 240 that may be the central portion of the interior cavity 215 and correspond to the hollow core 140 of the hollow-core optical fiber 100 that may be drawn from the hollow-core preform 200. In some embodiments, the outer tube 210, the inner tubes 220, and/or the nested tubes 230 may include silica glass and/or silica-based glass (i.e., silica glass comprising one or more dopants).

### Fiber Drawing System

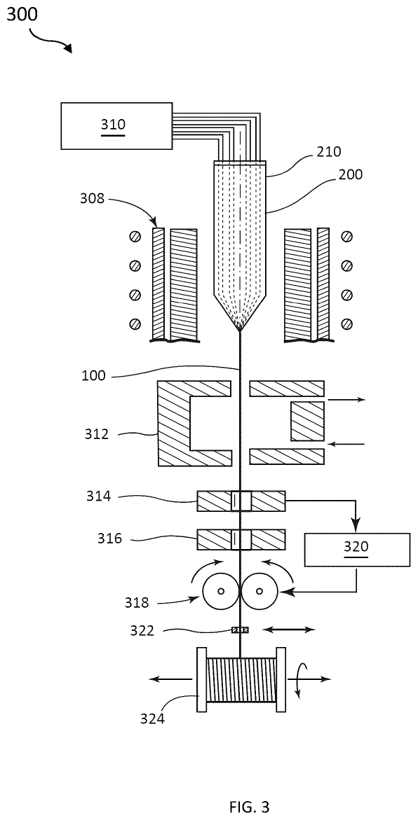

FIG. 3 schematically depicts an example of a drawing system 300 that may be utilized to produce the hollow-core optical fiber 100 from the hollow-core preform 200.

In some embodiments, the drawing system 300 may include a draw furnace 308 configured for receiving and heating the hollow-core preform 200, thereby subjecting the hollow-core preform 200 to a draw temperature. After, and as, the hollow-core preform 200 is subjected to the draw temperature, the hollow-core preform 200 may be necked down, and the hollow-core optical fiber 100 may be drawn from the hollow-core preform 200. The draw furnace 308 may include a hot zone, which is defined as the axial span of the heating elements that are used to heat up the preform for drawing into fiber. An axial length of the hot zone may be greater than or equal to (i.e., ≥) 3 cm and less than or equal to (i.e., <) 50 cm—including all sub-ranges or values therebetween. For example, in some embodiments, the axial length of the hot zone may be ≥3 cm and ≤50 cm, ≥3 cm and ≤40 cm, ≥3 cm and ≤30 cm, ≥3 cm and ≤20 cm, ≥3 cm and ≤10 cm, ≥10 cm and ≤50 cm, ≥10 cm and ≤40 cm, ≥10 cm and ≤30 cm, ≥10 cm and ≤20 cm, ≥20 cm and ≤50 cm, ≥20 cm and ≤40 cm, ≥20 cm and ≤30 cm, ≥30 cm and ≤50 cm, ≥30 cm and ≤40 cm, or ≥40 cm and ≤50 cm. In some embodiments, the axial length of the hot zone may be ≥3 cm, ≥5 cm, ≥10 cm, ≥15 cm, ≥20 cm, ≥25 cm, ≥30 cm, ≥35 cm, ≥40 cm, ≥45 cm, or greater. In some embodiments, the axial length of the hot zone may be ≤50 cm, ≤45 cm, ≤40 cm, ≤35 cm, ≤30 cm, ≤25 cm, ≤20 cm, ≤15 cm, ≤10 cm, ≤5 cm, or less.

In some embodiments, the drawing system 300 may further include a pressure control system 310. The pressure control system 310 may be coupled to and configured for pressuring the interior cavities of the outer tube 210, the inner tubes 220, and/or the nested tubes 230 (if present) of the hollow-core preform 200. In some embodiments, the pressure control system 310 may include any or all of a pressure sensor, a vacuum system, a gas pressure source or gas supply, and/or a controller for monitoring the pressure(s) within the various cavities mentioned above and using vacuum and/or gas pressure to maintain the pressure(s) at a desired value(s). In some embodiments, the pressure control system 310 may include a manifold connected to the gas pressure source or gas supply for supplying gas to the hollow-core preform 200. The pressure(s) within the cavities mentioned above may at least in part determine the dimensions, such as radii, of the outer cladding 110, the capillaries 120, and/or the nested capillaries 130 of the hollow-core optical fiber 100, as will be discussed in more detail below.

In some embodiments, the drawing system 300 may further include a cooling chamber 312 to cool the hollow-core optical fiber 100. In some embodiments, the drawing system 300 may further include a non-contact sensor 314 for measuring the dimension, e.g., diameter of the outer surface 112 of the outer cladding 110. In some embodiments, the drawing system 300 may further include a coating apparatus 316 for applying and/or curing one or more coatings over the outer cladding 110.

In some embodiments, the drawing system 300 may further include a tension assembly 318, such as tractor, for applying a draw tension to draw the hollow-core optical fiber 100 from the hollow-core preform 200. The draw tension may be controlled via a control apparatus 320 to at least in part maintain the dimension of the hollow-core optical fiber 100 at a predetermined set point. In some embodiments, the drawing system 300 may further include a feedhead 322 for winding the hollow-core optical fiber 100 onto a storage spool 324.

### Evolution of Outer Tube to Outer Cladding

### (a) Finite Analytical Solution of Evolution of Preform Outer Tube Dimensions During Drawing

As discussed above, during the drawing of the hollow-core optical fiber, the hollow-core preform may be necked down, and the dimensions, e.g., the inner diameter/radius and outer diameter/radius, of the outer tube in the neckdown region evolve as they are subject to forces of surface tension, core pressure, and draw tension. The neckdown region refers to the region of the hollow-core preform between the axial location where the dimension(s) of the hollow-core preform, e.g., the outer diameter of the hollow-core preform, begins to reduce and the axial location where the final dimension(s), e.g., the outer diameter of the hollow-core optical fiber, is reached.

The evolution of the outer radius, R_{oc}, and the inner radius, r_{oc}, of the outer tube in the neckdown region is given by the following relation:

$$\frac{d}{dz} ( {r}_{oc}^{2} {V}_{z} ) = \frac{d}{dz} ( {R}_{oc}^{2} {V}_{z} ) = \frac{{P}_{core} {r}_{oc}^{2} {R}_{oc}^{2} - {σ}_{oc} {r}_{oc} {R}_{oc} ( {r}_{oc} + {R}_{oc} )}{μ ( {R}_{oc}^{2} - {r}_{oc}^{2} )} \qquad [ 1 ]$$

where z is the axial distance in the neckdown region, V_{z} is the axial velocity, Pₑₒᵣₑ is the differential core pressure, σ_{oc} is the surface energy of the glass material forming the outer tube (e.g., 300 dynes/cm for silica glass), and p is the glass viscosity. The surface energy can be measured using the method described in Glass Engineering Handbook, 2nd Edition, by Shand, E. B.; Greene, C. H.; Grant, J. A.; Armistead, W. H., the content of which is incorporated by reference herein. The differential core pressure Pₑₒᵣₑ, which may also be referred to as the gauge pressure P_{core}, is defined as the pressure difference between the pressure inside the interior cavity of the outer tube of the hollow-core preform and the atmospheric pressure around the exterior of the outer tube of the hollow-core preform.

The draw tension under which the hollow-core optical fiber may be drawn from the hollow-core preform is given as:

$$T = 3 μ \frac{d ( {V}_{z} )}{dz} π ( {R}_{oc}^{2} - {r}_{oc}^{2} ) \qquad [ 2 ]$$

Using a Corrocco type transformation and using Equation [2]to transform Equation Eq. [1]with axial velocity as the independent variable, the following is obtained:

$$\frac{d}{{dV}_{z}} ( {r}_{oc} ) = \frac{3 π ( {P}_{core} {r}_{oc} {R}_{oc}^{2} - σ {R}_{oc} ( {R}_{oc} + {r}_{oc} ) )}{2 {TV}_{z}} - \frac{{r}_{oc}}{2 {V}_{z}} \qquad [ 3 a ]$$

$$\frac{d}{{dV}_{z}} ( {R}_{oc} ) = \frac{3 π ( {P}_{core} {R}_{oc} {r}_{oc}^{2} - σ {r}_{oc} ( {R}_{oc} + {r}_{oc} ) )}{2 {TV}_{z}} - \frac{{R}_{oc}}{2 {V}_{z}} \qquad [ 3 b ]$$

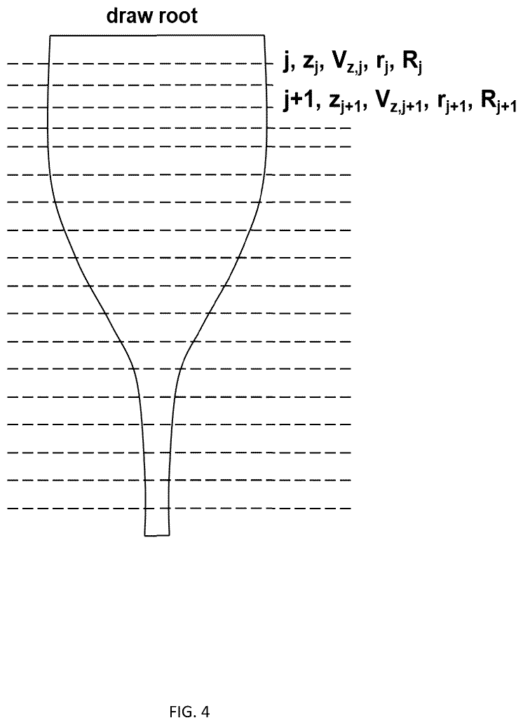

To capture the evolution of the outer radius R_{oc} and the inner radius r_{oc} of the outer tube of the hollow-core preform in the neckdown region, a finite-analytic solution, as shown in FIG. 4, is implemented, where the analytic solution between the ith and the (i+1) the node is given as:

$${r}_{oc , j + 1} = ( \frac{3 π {R}_{oc , j}^{2} σ}{T + 3 π {R}_{oc , j} σ - 3 π {P}_{core} {R}_{oc , j}^{2}} ) + ( {r}_{oc , j} - \frac{3 π {R}_{oc , j}^{2} σ}{T + 3 π {R}_{oc , j} σ - 3 π {P}_{core} {R}_{oc , j}^{2}} ) \text{} {( \frac{{V}_{z , j + 1}}{{V}_{z , j}} )}^{- ( T + 3 π {R}_{oc , j} σ - 3 π {P}_{core} {R}_{oc , j}^{2} ) / 2 T} \qquad [ 4 a ]$$

$${R}_{oc , j + 1} = ( \frac{3 π {r}_{oc , j}^{2} σ}{T + 3 π {r}_{oc , j} σ - 3 π {P}_{core} {r}_{oc , j}^{2}} ) + ( {R}_{oc , j} - \frac{3 π {r}_{oc , j}^{2} σ}{T + 3 π {r}_{oc , j} σ - 3 π {P}_{core} {r}_{oc , j}^{2}} ) \text{} \text{} {( \frac{{V}_{z , j + 1}}{{V}_{z , j}} )}^{- ( T + 3 π {r}_{oc , j} σ - 3 π {P}_{core} {r}_{oc , j}^{2} ) / 2 T} \qquad [ 4 b ]$$

which can be implemented with the mass balance equation as:

$${V}_{z , j + 1} ( {R}_{oc , j + 1}^{2} - {r}_{oc , j + 1}^{2} ) = {V}_{z , j} ( {R}_{oc , j}^{2} - {r}_{oc , j}^{2} ) \qquad [ 5 ]$$

### (b) Exemplary Implementations of the Finite-Analytic Solution

The finite-analytic solution was implemented for different preform geometries that resulted in the same inner diameter of the outer cladding of the hollow-core fiber (2×r_{ocf}) of about 79.7 μm, and the same outer diameter of the outer cladding of the hollow-core optical fiber (2×R_{ocf}) of about 249 μm. However, it should be noted that the present disclosure is not limited to these specific fiber target dimensions (i.e., inner diameter of 79.7 μm and outer diameter of 249 μm), which are used for non-limiting illustrative purposes. The present disclosure may be implemented for achieving other target dimensions of the hollow-core optical fiber from different preform dimensions. For example, the solution described herein may be utilized for achieving any target inner diameter of the outer cladding of the hollow-core optical fiber that may be greater than or equal to (i.e., ≥) 45 μm and less than or equal to (i.e., ≤) 145 μm —including all sub-ranges or values therebetween. Similarly, the solution described herein may also be utilized for achieving any target outer diameter of the outer cladding of the hollow-core optical fiber that may be greater than or equal to (i.e., ≥) 150 μm and less than or equal to (i.e., ≤) 300 μm—including all sub-ranges or values therebetween.

Table 1 below shows that different combinations of pressure, draw tension, and preform geometries that result in substantially the same inner and outer diameters of the outer cladding of the hollow-core optical fiber. As shown in Table 1, the various outer diameters of the outer tube of the hollow-core preform (2×R_{ocp}) between 17 mm and 50 mm and the various inner diameters of the outer tube of the hollow-core preform (2×r_{ocp}) between 5 mm and 9 mm result in substantially the same outer cladding dimensions of the hollow-core optical fiber, with the fiber draw speeds ranging between 1 m/s and 10 m/s.

TABLE 1

| | | | | | | | | | Fiber |
|---|---|---|---|---|---|---|---|---|---|
| | Preform | Preform | Fiber | Fiber | | Differential | Preform | Fiber | Draw |
| | OD, | ID, | OD, | ID, | Draw | Core | Feed | Draw | Speed, |
| | 2 × R_{ocp} | 2 × r_{ocp} | 2 × R_{ocf} | 2 × r_{ocf} | Tension, | Pressure, | Rate, Vₚ | Rate, V_{f} | V_{f}/60000 |
| Ex | (mm) | (mm) | (um) | (um) | T_{g} (g) | P_{core} (psig) | (mm/min) | (mm/min) | (m/sec) |
| 1 | 17.25 | 5 | 248.5 | 79.72 | 100 | 0.014 | 12.5 | 60000 | 1.00 |
| 2 | 17.25 | 5 | 249.4 | 79.67 | 150 | 0.032 | 12.5 | 60000 | 1.00 |
| 3 | 17.25 | 5 | 249.85 | 79.64 | 200 | 0.05 | 12.5 | 60000 | 1.00 |
| 4 | 17.25 | 5 | 250.12 | 79.71 | 250 | 0.069 | 12.5 | 60000 | 1.00 |
| 5 | 17.25 | 5 | 250.32 | 79.69 | 300 | 0.087 | 12.5 | 60000 | 1.00 |
| 6 | 25.875 | 7 | 246.96 | 79.73 | 100 | 0.013 | 12.5 | 136858.2 | 2.28 |
| 7 | 25.875 | 7 | 248.625 | 79.625 | 150 | 0.027 | 12.5 | 136857.4 | 2.28 |
| 8 | 25.875 | 7 | 248.99 | 79.81 | 200 | 0.04 | 12.5 | 136857 | 2.28 |
| 9 | 25.875 | 7 | 249.3775 | 79.74 | 250 | 0.056 | 12.5 | 136856.8 | 2.28 |
| 10 | 25.875 | 7 | 249.63 | 79.69 | 300 | 0.07 | 12.5 | 136856.6 | 2.28 |
| 11 | 34.6 | 8 | 246.99 | 79.72 | 100 | 0.018 | 12.5 | 247134.8 | 4.12 |
| 12 | 34.6 | 8 | 248.719 | 79.72 | 150 | 0.0335 | 12.5 | 247132.8 | 4.12 |
| 13 | 34.6 | 8 | 249.6 | 79.89 | 200 | 0.049 | 12.5 | 247131.8 | 4.12 |
| 14 | 34.6 | 8 | 250.08 | 79.77 | 250 | 0.064 | 12.5 | 247130.2 | 4.12 |
| 15 | 34.6 | 8 | 250.04 | 79.688 | 300 | 0.079 | 12.5 | 247130.8 | 4.12 |
| 16 | 49.6 | 9 | 246.42 | 79.63 | 100 | 0.0157 | 12.5 | 512464.3 | 8.54 |
| 17 | 49.6 | 9 | 248.74 | 79.82 | 150 | 0.0287 | 12.5 | 512458.3 | 8.54 |
| 18 | 49.6 | 9 | 249.88 | 79.78 | 200 | 0.0415 | 12.5 | 512455.3 | 8.54 |
| 19 | 49.6 | 9 | 250.58 | 79.77 | 250 | 0.0543 | 12.5 | 512453.4 | 8.54 |
| 20 | 49.6 | 9 | 251.03 | 79.706 | 300 | 0.067 | 12.5 | 512452.2 | 8.54 |

### (c) Approximate Solution of Preform Outer Tube Dimensions

Based on the example shown in Table 1, the following relations can be approximated for the differential core pressure Pₑₒᵣₑ as a function of draw tension T_{g} in grams:

$${P}_{core} ( psig ) ∼ 1.877 \times 1 {0}^{- 5} \times {T}_{g}^{1.46} \qquad [ 6 ]$$

Further, the following relations can be approximated for the inner radius r_{ocp} and the outer radius R_{ocp} of the outer tube of the hollow-core preform:

$${r}_{ocp} ∼ \frac{{r}_{ocf}}{{( {V}_{f} / {V}_{p} )}^{- ( T + 3 π {R}_{*} {σ}_{oc} - 3 π {P}_{core} {R}_{*}^{2} ) / 2 T}} \qquad [ 7 a ]$$

$${R}_{ocp} ∼ \frac{{R}_{ocf}}{{( {V}_{f} / {V}_{p} )}^{- ( T + 3 π {r}_{*} {σ}_{oc} - 3 π {P}_{core} {r}_{*}^{2} ) / 2 T}} \qquad [ 7 b ]$$

where r_{ocf} and R_{ocf} are the inner and outer radii, respectively, of the outer cladding of the hollow-core optical fiber, Vₚ is the hollow-core preform feed rate, V_{f} is the hollow-core fiber draw rate, T is the draw tension in dynes and T=T_{g}*981, σ_{oc} is the surface energy of the glass material forming the outer tube (taken to be 300 dynes/cm), and r* and R* are given as:

$${r}_{*} ∼ 5 \sqrt{{r}_{ocp} {r}_{ocf}} \qquad [ 8 a ]$$

$${R}_{*} ∼ 5 \sqrt{{R}_{ocp} {R}_{ocf}} \qquad [ 8 b ]$$

Based on the approximate solutions above, the inventor has found that when the differential core pressure P_{core} satisfies the following relation:

$$0.8 \times {P}^{*} < {P}_{core} < 1.2 \times {P}^{*} \qquad [ 9 ]$$

where P*=1.877×10⁻⁵×T_{g}^{1.46} consistent target inner radius r_{ocf} and consistent target outer radius R_{ocf} of the outer cladding of the hollow-core optical fiber can be achieved with preforms having outer tuber inner radius r_{ocp} and outer tube outer radius R_{ocp} that satisfy the following relations:

$$0.9 \times {r}_{p}^{*} < {r}_{ocp} < 1.1 \times {r}_{p}^{*} \qquad [ 10 a ]$$

$$0.95 \times {R}_{p}^{*} < {R}_{ocp} < 1.05 \times {R}_{p}^{*} \qquad [ 10 b ]$$

$$where :$$

$${r}_{p}^{*} = \frac{{r}_{ocf}}{{( {V}_{f} / {V}_{p} )}^{- ( T + 3 π {R}_{*} σ - 3 π {P}_{core} {R}_{*}^{2} ) / 2 T}} \qquad [ 11 a ]$$

$${R}_{p}^{*} = \frac{{R}_{ocf}}{{( {V}_{f} / {V}_{p} )}^{- ( T + 3 π {r}_{*} σ - 3 π {P}_{core} {r}_{*}^{2} ) / 2 T}} \qquad [ 11 b ]$$

$$and$$

$${r}_{*} = 5 \sqrt{{r}_{p}^{*} {r}_{ocf}} \qquad [ 12 a ]$$

$${R}_{*} = 5 \sqrt{{R}_{p}^{*} {R}_{ocf}} \qquad [ 12 b ]$$

### Evolution of Inner Tubes to Capillaries

### (a) Evolution of Preform Inner Tube Dimensions During Drawing

The evolution of the inner radius r_{c}, and outer radius, R_{c}, of the inner tube in the neckdown region is described by the following relation:

$$\frac{d}{dz} ( {r}_{c}^{2} {V}_{z} ) = \frac{d}{dz} ( {R}_{c}^{2} {V}_{z} ) = ( Δ {p}_{c} - \frac{{σ}_{c} ( {R}_{c} + {r}_{c} )}{{R}_{c} {r}_{c}} ) \frac{{r}_{c}^{2} {R}_{c}^{2}}{μ ( {R}_{c}^{2} - {r}_{c}^{2} )} \qquad [ 13 ]$$

where z is the axial distance in the neckdown region, V_{z} is the axial velocity, Δp_{c} is the differential capillary pressure in dynes/cm², σ_{c} is the surface energy of the glass material forming the inner tube (e.g., 300 dynes/cm for silica glass), and p is the glass viscosity. The differential capillary pressure Δp_{c} is defined as the difference between the pressure inside the interior cavity of each inner tube and the pressure outside the inner tubes, i.e., the pressure inside the interior cavity of the outer tube of the hollow-core preform. Equation [13]for thin capillaries can be transformed with axial velocity in the neck down region, Vz, as the independent variables as:

$$\frac{d}{{dV}_{z}} ( {r}_{c} ) = \frac{3 π ( {R}^{2} - {r}^{2} ) {R}_{c} ( Δ {p}_{c} {r}_{c} - 2 {σ}_{c} )}{4 {TV}_{z} ( {R}_{c} - {r}_{c} )} - \frac{{r}_{c}}{2 {V}_{z}} \qquad [ 14 a ]$$

$$\frac{d}{{dV}_{z}} ( {R}_{c} ) = \frac{3 π ( {R}^{2} - {r}^{2} ) {r}_{c} ( Δ {p}_{c} {R}_{c} - 2 {σ}_{c} )}{4 {TV}_{z} ( {R}_{c} - {r}_{c} )} - \frac{{R}_{c}}{2 {V}_{z}} \qquad [ 14 b ]$$

where T is the draw tension in dynes, and T=T_{g}*981.
(i) Non-Dimensional Parameters X₁ and X₂

For characterizing the evolution from the inner tubes of the hollow-core preform to the capillaries of the hollow-core optical fiber during the drawing process, two non-dimensional parameters based on the structure in the starting hollow-core preform are defined as:

$${X}_{1} = \frac{3 π ( {R}_{ocp}^{2} - {r}_{ocp}^{2} ) {R}_{cp} ( Δ {p}_{c} {r}_{cp} - 2 {σ}_{c} )}{4 {Tr}_{cp} ( {R}_{cp} - {r}_{cp} )} \qquad [ 15 ]$$

$${X}_{2} = \frac{3 π ( {R}_{ocp}^{2} - {r}_{ocp}^{2} ) {r}_{cp} ( Δ {p}_{c} {R}_{cp} - 2 {σ}_{c} )}{4 T {R}_{cp} ( {R}_{cp} - {r}_{cp} )} \qquad [ 16 ]$$

where R_{ocp} is the outer radius of the outer tube of the starting hollow-core preform, r_{ocp} is the inner radius of the outer tube of the starting hollow-core preform, R_{cp} is the outer radius of the inner tube of the starting hollow-core preform, and r_{cp} is the inner radius of the inner tube of the starting hollow-core preform, Δp_{c} is the differential capillary pressure in dynes/cm², σ_{c} is the surface energy of the glass material forming the inner tube (e.g., 300 dynes/cm for silica glass), and T is the draw tension in dynes, and T=T_{g}*981.

The inventor has found that smaller values of the non-dimensional parameters X₁ and X₂ may result in collapse of the capillaries. The inventor has also found that larger values of the non-dimensional parameters X₁ and X₂ may result in very large capillaries and process conditions the small changes of which, such as small change in pressure, can result in much more significant change in the capillary diameters as discussed in more detail below. The inventor has found that ranges of the non-dimensional parameters X₁ and X₂ may be selected (by, e.g., choosing appropriate incoming preform dimensions, maintaining appropriate differential capillary pressure levels, applying appropriate draw tension values, etc.) such that relatively small changes in process conditions would not significantly alter the dimensions of the capillaries significantly, thereby achieving target capillary dimensions with precise during scale-up manufacturing.

In some embodiments, the non-dimensional parameter X₁ may be greater than or equal to (i.e., ≥)−0.5 and less than or equal to (i.e., ≤) 0.75—including all sub-ranges or values therebetween—for stable drawing of the capillaries of the hollow-core optical fibers. For example, in some embodiments, the non-dimensional parameter X₁ may be ≥0 and ≤0.7 for stable drawing of the capillaries of the hollow-core optical fibers. In some embodiments, the non-dimensional parameter X₁ may be ≥0.25 and ≤0.65 for stable drawing of the capillaries of the hollow-core optical fibers. In some embodiments, the non-dimensional parameter X₁ may be ≥−0.5 and ≤0.75, ≥−0.5 and ≤0.5, ≥−0.5 and ≤0.25, ≥−0.5 and ≤0, ≥−0.5 and <−0.25, ≥−0.25 and ≤0.75, ≥−0.25 and ≤0.5, ≥−0.25 and ≤0.25, ≥−0.25 and ≤0, ≥0 and ≤0.75, ≥0 and ≤0.5, ≥0 and ≤0.25, ≥0.25 and ≤0.75, ≥0.25 and ≤0.5, or ≥0.5 and ≤0.75. In some embodiments, the non-dimensional parameter X₁ may be greater than or equal to (i.e., ≥) −0.5, ≥−0.4, ≥−0.3, ≥−0.2, ≥−0.1, ≥0, ≥0.05, ≥0.1, ≥0.15, ≥0.2, ≥0.25, ≥0.3, ≥0.35, ≥0.4, ≥0.45, ≥0.5, ≥0.55, ≥0.6, ≥0.65, ≥0.7, or greater. In some embodiments, the non-dimensional parameter X₁ may be less than or equal to (i.e., ≤) 0.75, ≤0.7, ≤0.65, ≤0.6, ≤0.55, ≤0.5, ≤0.45, ≤0.4, ≤0.35, ≤0.3, ≤0.25, ≤0.2, ≤0.15, ≤0.1, ≤0.05, ≤0, ≤−0.1, ≤−0.2, ≤−0.3, ≤−0.4, or less.

In some embodiments, the non-dimensional parameter X₂ may be greater than or equal to (i.e., ≥) −0.35 and less than or equal to (i.e., ≤) 0.6—including all sub-ranges or values therebetween—for stable drawing of the capillaries of the hollow-core optical fibers. In some embodiments, the non-dimensional parameter X₂ may be ≥0 and ≤0.55 for stable drawing of the capillaries of the hollow-core optical fibers. In some embodiments, the non-dimensional parameter X₂ may be ≥0.18 and ≤0.5 for stable drawing of the capillaries of the hollow-core optical fibers. In some embodiments, the non-dimensional parameter X₂ may be ≥0.2 and ≤0.5 for stable drawing of the capillaries of the hollow-core optical fibers. In some embodiments, the non-dimensional parameter X₂ may be ≥−0.35 and ≤0.6, ≥−0.35 and ≤0.4, ≥−0.35 and ≤0.2, ≥−0.35 and ≤0, ≥−0.35 and <−0.2, ≥−0.2 and ≤0.6, ≥−0.2 and ≤0.4, ≥−0.2 and ≤0.2, ≥−0.2 and <0, ≥0 and ≤0.6, ≥0 and ≤0.4, ≥0 and ≤0.2, ≥0.2 and ≤0.6, ≥0.2 and ≤0.4, or ≥0.4 and ≤0.6. In some embodiments, the non-dimensional parameter X₂ may be greater than or equal to (i.e., ≥) −0.35, ≥−0.3, ≥−0.2, ≥−0.1, ≥0, ≥0.05, ≥0.1, ≥0.15, ≥0.2, ≥0.25, ≥0.3, ≥0.35, ≥0.4, ≥0.45, ≥0.5, ≥0.55, or greater. In some embodiments, the non-dimensional parameter X₂ may be less than or equal to (i.e., ≤) 0.6, ≤0.55, ≤0.5, ≤0.45, ≤0.4, ≤0.35, ≤0.3, ≤0.25, ≤0.2, ≤0.15, ≤0.1, ≤0.05, ≤0, ≤−0.1, ≤−0.2, ≤−0.3, or less.

### (ii) Non-Dimensional Parameters X₃ and X₄

For characterizing the evolution from the nested tubes of the hollow-core preform to the nested capillaries of the hollow-core optical fiber during the drawing process, two non-dimensional parameters based on the structure in the starting hollow-core preform are defined as:

$${X}_{3} = \frac{3 π ( {R}_{ocp}^{2} - {r}_{ocp}^{2} ) {R}_{ncp} ( Δ {p}_{nc} {r}_{ncp} - 2 {σ}_{nc} )}{4 {Tr}_{ncp} ( {R}_{ncp} - {r}_{ncp} )} \qquad [ 17 ]$$

$${X}_{4} = \frac{3 π ( {R}_{ocp}^{2} - {r}_{ocp}^{2} ) {r}_{ncp} ( Δ {p}_{nc} {R}_{ncp} - 2 {σ}_{nc} )}{4 T {R}_{ncp} ( {R}_{ncp} - {r}_{ncp} )} \qquad [ 18 ]$$

where R_{ocp} is the outer radius of the outer tube of the starting hollow-core preform, r_{ocp} is the inner radius of the outer tube of the starting hollow-core preform, R_{ncp} is the outer radius of the nested tube of the starting hollow-core preform, and r_{ncp} is the inner radius of the nested tube of the starting hollow-core preform, Δp_{nc} is the differential nested capillary pressure in dynes/cm², which is defined as the difference between the pressure inside the interior cavity of each nested tube and the pressure outside the nested tubes, i.e., the pressure inside the interior cavity of the inner tubes of the hollow-core preform, an is the surface energy of the glass material forming the nested tube (taken to be 300 dynes/cm), and T is the draw tension in dynes, and T=T_{g}*981.

The inventor has found that smaller values of the non-dimensional parameters X₃ and X₄ may result in collapse of the nested capillaries. The inventor has also found that larger values of the non-dimensional parameters X₃ and X₄ may result in very large nested capillaries and process conditions the small changes of which, such as small change in pressure, can result in much more significant change in the capillary diameters as discussed in more detail below. The inventor has found that ranges of the non-dimensional parameters X₃ and X₄ may be selected (by, e.g., choosing appropriate incoming preform dimensions, maintaining appropriate differential nested capillary pressure levels, applying appropriate draw tension values, etc.) such that relatively small changes in process conditions would not significantly alter the dimensions of the nested capillaries significantly, thereby achieving target capillary dimensions with precise during scale-up manufacturing.

In some embodiments, the non-dimensional parameter X₃ may be greater than or equal to (i.e., ≥) −0.5 and less than or equal to (i.e., ≤) 0.75—including all sub-ranges or values therebetween—for stable drawing of the nested capillaries of the hollow-core optical fibers. For example, in some embodiments, the non-dimensional parameter X₃ may be ≥0 and ≤0.7 for stable drawing of the nested capillaries of the hollow-core optical fibers. In some embodiments, the non-dimensional parameter X₃ may be ≥0.25 and ≤0.65 for stable drawing of the nested capillaries of the hollow-core optical fibers. In some embodiments, the non-dimensional parameter X₃ may be ≥−0.5 and ≤0.75, ≥−0.5 and ≤0.5, ≥−0.5 and ≤0.25, ≥−0.5 and ≤0, ≥−0.5 and <−0.25, ≥−0.25 and ≤0.75, ≥−0.25 and ≤0.5, ≥−0.25 and ≤0.25, ≥−0.25 and ≤0, ≥0 and <0.75, ≥0 and ≤0.5, ≥0 and ≤0.25, ≥0.25 and ≤0.75, ≥0.25 and ≤0.5, or ≥0.5 and ≤0.75. In some embodiments, the non-dimensional parameter X₃ may be greater than or equal to (i.e., ≥) −0.5, ≥−0.4, ≥−0.3, ≥−0.2, ≥−0.1, ≥0, ≥0.05, ≥0.1, ≥0.15, ≥0.2, ≥0.25, ≥0.3, ≥0.35, ≥0.4, ≥0.45, ≥0.5, ≥0.55, ≥0.6, ≥0.65, ≥0.7, or greater. In some embodiments, the non-dimensional parameter X₃ may be less than or equal to (i.e., ≤) 0.75, ≤0.7, ≤0.65, ≤0.6, ≤0.55, ≤0.5, ≤0.45, ≤0.4, ≤0.35, ≤0.3, ≤0.25, ≤0.2, ≤0.15, ≤0.1, ≤0.05, ≤0, ≤−0.1, ≤−0.2, ≤−0.3, ≤−0.4, or less.

In some embodiments, the non-dimensional parameter X₄ may be greater than or equal to (i.e., ≥) −0.35 and less than or equal to (i.e., ≤) 0.6—including all sub-ranges or values therebetween—for stable drawing of the nested capillaries of the hollow-core optical fibers. In some embodiments, the non-dimensional parameter X₄ may be ≥0 and ≤0.55 for stable drawing of the nested capillaries of the hollow-core optical fibers. In some embodiments, the non-dimensional parameter X₄ may be ≥0.18 and ≤0.5 for stable drawing of the nested capillaries of the hollow-core optical fibers. In some embodiments, the non-dimensional parameter X₄ may be ≥0.2 and ≤0.5 for stable drawing of the nested capillaries of the hollow-core optical fibers. In some embodiments, the non-dimensional parameter X₄ may be ≥−0.35 and ≤0.6, ≥−0.35 and <0.4, ≥−0.35 and ≤0.2, ≥−0.35 and ≤0, ≥−0.35 and <−0.2, ≥−0.2 and ≤0.6, ≥−0.2 and ≤0.4, ≥−0.2 and ≤0.2, ≥−0.2 and ≤0, ≥0 and ≤0.6, ≥0 and ≤0.4, ≥0 and ≤0.2, ≥0.2 and ≤0.6, ≥0.2 and ≤0.4, or ≥0.4 and ≤0.6. In some embodiments, the non-dimensional parameter X₄ may be greater than or equal to (i.e., ≥) −0.35, ≥−0.3, ≥−0.2, ≥−0.1, ≥0, ≥0.05, ≥0.1, ≥0.15, ≥0.2, ≥0.25, ≥0.3, ≥0.35, ≥0.4, ≥0.45, ≥0.5, ≥0.55, or greater. In some embodiments, the non-dimensional parameter X₄ may be less than or equal to (i.e., ≤) 0.6, ≤0.55, ≤0.5, ≤0.45, ≤0.4, ≤0.35, ≤0.3, ≤0.25, ≤0.2, ≤0.15, ≤0.1, ≤0.05, ≤0, ≤−0.1, ≤−0.2, ≤−0.3, or less.

The inventor has found that by selecting the appropriate preform dimensions (e.g., inner and outer radii of the outer tube, inner tubes, and/or nested tubes) and/or the drawing conditions (e.g., draw tension, differential capillary pressures, differential nested capillary pressures, etc.), appropriate values of non-dimensional parameters X₁, X₂, X₃, and X₄ with the various range described above may be obtained for achieving various target dimensions of the capillaries and/or nested capillaries.

### (b) Exemplary Implementations

The below examples are intended to be exemplary and are not intended to limit the scope of the disclosure. Tables 2-5 show the inner and outer diameters of the capillaries of the hollow-core optical fiber drawn as a function of differential capillary pressure for different draw tensions for preforms having outer tube outer diameter ranging between 17 mm and 50 mm and fiber draw speeds ranging between 1 m/s and 10 m/s. In Tables 2-5 below, the differential capillary pressure is shown as “Capillary dP” in dynes/cm².

TABLE 2-A

| | |
|---|---|
| Preform Outer Tube OD, 2 × R_{ocp} (mm) | 17.25 |
| Preform Outer Tube ID, 2 × r_{ocp} (mm) | 5 |
| Preform Inner Tube OD, 2 × R_{cp} (mm) | 1.1 |
| Preform Inner Tube ID, 2 × r_{cp} (mm) | 0.85 |
| Fiber Draw Speed (m/s) | 1 |
| Fiber Outer Cladding OD, 2 × R_{ocf} (μm) | 250 |
| Fiber Outer Cladding ID, 2 × r_{ocf} (μm) | 79.7 |

TABLE 2-B1
Tension (g) 200
P_{core} (psig) 0.05

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.423 | −0.326 | 3.026 | 6 |
| 5000 | −0.273 | −0.211 | 3.76 | 6.74 |
| 10000 | −0.123 | −0.095 | 4.728 | 7.706 |
| 15000 | 0.026 | 0.02 | 6.024 | 9.002 |
| 20000 | 0.176 | 0.136 | 7.851 | 10.829 |
| 25000 | 0.326 | 0.252 | 10.594 | 13.253 |
| 30000 | 0.476 | 0.367 | 15.114 | 18.09 |
| 35000 | 0.625 | 0.483 | 23.749 | 26.727 |
| 40000 | 0.775 | 0.599 | 45.68 | 48.611 |
| 45000 | 0.925 | 0.715 | 174.42 | 177.39 |

TABLE 2-B2
Tension (g) 300
P_{core} (psig) 0.087

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.282 | −0.218 | 4.82 | 7.8 |
| 5000 | −0.182 | −0.14 | 5.49 | 8.472 |
| 10000 | −0.082 | −0.063 | 6.295 | 9.274 |
| 15000 | 0.017 | 0.0136 | 7.271 | 10.25 |
| 20000 | 0.117 | 0.091 | 8.483 | 11.461 |
| 25000 | 0.217 | 0.168 | 10.02 | 13.007 |
| 30000 | 0.317 | 0.245 | 12.03 | 15.01 |
| 35000 | 0.417 | 0.322 | 14.76 | 17.74 |
| 40000 | 0.517 | 0.399 | 18.66 | 21.69 |
| 45000 | 0.617 | 0.476 | 24.61 | 27.59 |
| 50000 | 0.717 | 0.554 | 34.69 | 37.67 |
| 55000 | 0.817 | 0.631 | 54.95 | 57.93 |
| 60000 | 0.917 | 0.708 | 112.71 | 115.69 |
| 65000 | 1.017 | 0.785 | 758.99 | 761.97 |

TABLE 2-B3
Tension (g) 400
P_{core} (psig) 0.125

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.211 | −0.163 | 5.91 | 8.89 |
| 5000 | −0.136 | −0.105 | 6.495 | 9.472 |
| 10000 | −0.0617 | −0.0477 | 7.164 | 10.14 |
| 15000 | 0.0132 | 0.102 | 7.94 | 10.91 |
| 20000 | 0.088 | 0.068 | 8.848 | 11.826 |
| 25000 | 0.163 | 0.126 | 9.923 | 12.902 |
| 30000 | 0.238 | 0.184 | 11.216 | 14.19 |
| 35000 | 0.313 | 0.241 | 12.7957 | 15.774 |
| 40000 | 0.388 | 0.2998 | 14.764 | 17.74 |
| 45000 | 0.463 | 0.357 | 17.278 | 20.256 |
| 50000 | 0.538 | 0.415 | 20.584 | 23.567 |
| 55000 | 0.612 | 0.473 | 25.125 | 28.1 |
| 60000 | 0.687 | 0.531 | 31.68 | 34.65 |
| 65000 | 0.762 | 0.589 | 41.88 | 44.86 |
| 70000 | 0.837 | 0.647 | 59.7 | 62.68 |
| 75000 | 0.917 | 0.705 | 97.61 | 100.79 |
| 80000 | 0.987 | 0.763 | 222.43 | 225.41 |

TABLE 2-B4
Tension (g) 500
P_{core} (psig) 0.16

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.169 | −0.1308 | 6.63 | 9.61 |
| 10000 | −0.049 | −0.038 | 7.713 | 10.69 |
| 20000 | 0.0705 | 0.0545 | 9.081 | 12.06 |
| 30000 | 0.19 | 0.147 | 10.862 | 13.841 |
| 40000 | 0.31 | 0.2399 | 13.264 | 16.24 |
| 50000 | 0.43 | 0.332 | 16.66 | 19.63 |
| 60000 | 0.55 | 0.425 | 21.78 | 24.76 |
| 70000 | 0.67 | 0.518 | 30.31 | 33.28 |
| 80000 | 0.79 | 0.61 | 46.89 | 49.873 |
| 90000 | 0.91 | 0.703 | 90.89 | 93.87 |
| 100000 | 1.03 | 0.796 | 411.773 | 414.751 |

TABLE 3-A

| | |
|---|---|
| Preform Outer Tube OD, 2 × R_{ocp} (mm) | 28.875 |
| Preform Outer Tube ID, 2 × r_{ocp} (mm) | 7 |
| Preform Inner Tube OD, 2 × R_{cp} (mm) | 1.5 |
| Preform Inner Tube ID, 2 × r_{cp} (mm) | 1.2 |
| Fiber Draw Speed (m/s) | 2.28 |
| Fiber Outer Cladding OD, 2 × R_{ocf} (μm) | 250 |
| Fiber Outer Cladding ID, 2 × r_{ocf} (μm) | 79.7 |

TABLE 3-B1
Tension (g) 200
P_{core} (psig) 0.04

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.775 | −0.62 | 0.245 | 2.57 |
| 2500 | −0.5812 | −0.465 | 0.606 | 2.93 |
| 5000 | −0.387 | −0.31 | 1.092 | 3.417 |
| 7500 | −0.193 | −0.155 | 1.776 | 4.1 |
| 10000 | 0 | 0 | 2.8 | 5.125 |
| 12500 | 0.193 | 0.155 | 4.473 | 6.798 |
| 15000 | 0.387 | 0.31 | 7.62 | 9.954 |
| 17500 | 0.5812 | 0.465 | 15.5055 | 17.63 |
| 20000 | 0.775 | 0.62 | 53.127 | 55.452 |

TABLE 3-B2
Tension (g) 300
P_{core} (psig) 0.07

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.516 | −0.413 | 1.96 | 4.285 |
| 2500 | −0.38772 | −0.31 | 2.4 | 4.7671 |
| 5000 | −0.258 | −0.206 | 2.948 | 5.27 |
| 7500 | −0.12924 | −0.1033 | 3.641 | 5.966 |
| 10000 | 0 | 0 | 4.54 | 6.869 |
| 12500 | 0.1292 | 0.1033 | 5.766 | 8.091 |
| 15000 | 0.258 | 0.206 | 7.497 | 9.822 |
| 17500 | 0.3877 | 0.3101 | 10.166 | 12.4409 |
| 20000 | 0.516 | 0.413 | 14.476 | 16.801 |
| 22500 | 0.646 | 0.516 | 22.966 | 25.29 |
| 25000 | 0.775 | 0.62 | 45.4208 | 47.745 |
| 27500 | 0.9046 | 0.7235 | 202.946 | 205.27 |

TABLE 3-B3
Tension (g) 400
P_{core} (psig) 0.1

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.387 | −0.31 | 3.193 | 5.519 |
| 5000 | −0.194 | −0.155 | 4.168 | 6.492 |
| 10000 | 0 | 0 | 5.57 | 7.896 |
| 15000 | 0.193 | 0.155 | 7.74 | 10.072 |
| 20000 | 0.387 | 0.31 | 11.5057 | 13.83 |
| 25000 | 0.581 | 0.465 | 19.32 | 21.65 |
| 30000 | 0.775 | 0.62 | 43.49 | 45.82 |
| 35000 | 0.969 | 0.775 | 618.93 | 621.25 |

TABLE 3-B4
Tension (g) 500
P_{core} (psig) 0.128

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.31 | −0.248 | 4.089 | 6.414 |
| 5000 | −0.155 | −0.124 | 5.006 | 7.331 |
| 10000 | 0 | 0 | 6.238 | 8.56 |
| 15000 | 0.155 | 0.124 | 7.968 | 10.29 |
| 20000 | 0.31 | 0.248 | 10.55 | 12.88 |
| 25000 | 0.465 | 0.372 | 14.788 | 17.11 |
| 30000 | 0.62 | 0.496 | 22.8 | 25.12 |
| 35000 | 0.775 | 0.62 | 42.76 | 45.09 |
| 40000 | 0.93 | 0.744 | 151.699 | 154.02 |

TABLE 4-A

| | |
|---|---|
| Preform Outer Tube OD, 2 × R_{ocp} (mm) | 34.6 |
| Preform Outer Tube ID, 2 × r_{ocp} (mm) | 8 |
| Preform Inner Tube OD, 2 × R_{cp} (mm) | 1.9 |
| Preform Inner Tube ID, 2 × r_{cp} (mm) | 1.4 |
| Fiber Draw Speed (m/s) | 4.12 |
| Fiber Outer Cladding OD, 2 × R_{ocf} (μm) | 250 |
| Fiber Outer Cladding ID, 2 × r_{ocf} (μm) | 79.7 |

TABLE 4-B1
Tension (g) 200
P_{core} (psig) 0.049

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.9215 | −0.679 | | |
| 2000 | −0.7605 | −0.52 | | |
| 4000 | −0.4914 | −0.362 | | |
| 6000 | −0.276 | −0.203 | 0.3692 | 3.216 |
| 8000 | −0.061 | −0.045 | 1.161 | 4 |
| 10000 | 0.1535 | 0.1131 | 2.4803 | 5.3312 |
| 12000 | 0.3686 | 0.2716 | 5.033 | 7.9008 |
| 14000 | 0.5836 | 0.43 | 11.75 | 14.59 |
| 16000 | 0.7986 | 0.588 | 54.14 | 56.99 |

TABLE 4-B2
Tension (g) 300
P_{core} (psig) 0.079

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.614 | −0.452 | 0.768 | 3.616 |
| 2000 | −0.471 | −0.347 | 1.1263 | 3.97 |
| 4000 | −0.327 | −0.241 | 1.5739 | 4.42 |
| 6000 | −0.184 | −0.135 | 2.148 | 4.995 |
| 8000 | −0.04 | −0.03 | 2.9018 | 5.74 |
| 10000 | 0.102 | 0.075 | 3.949 | 6.79 |
| 12000 | 0.245 | 0.1811 | 5.46 | 8.306 |
| 14000 | 0.3893 | 0.286 | 7.817 | 10.66 |
| 16000 | 0.532 | 0.392 | 11.929 | 14.77 |
| 18000 | 0.676 | 0.498 | 20.63 | 23.47 |
| 20000 | 0.819 | 0.603 | 48.62 | 51.46 |
| 22000 | 0.963 | 0.709 | 1343.37 | 1346.22 |

TABLE 4-B3
Tension (g) 400
P_{core} (psig) 0.11

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.4611 | −0.339 | 1.925 | 4.772 |
| 2000 | −0.353 | −0.26 | 2.302 | 5.149 |
| 4000 | −0.249 | −0.181 | 2.752 | 5.59 |
| 6000 | −0.1383 | −0.101 | 3.297 | 6.144 |
| 8000 | −0.03 | −0.022 | 3.968 | 6.816 |
| 10000 | 0.0768 | 0.0566 | 4.813 | 7.66 |
| 12000 | 0.1844 | 0.135 | 5.903 | 8.752 |
| 14000 | 0.292 | 0.215 | 7.362 | 10.2 |
| 16000 | 0.399 | 0.294 | 9.394 | 12.242 |
| 18000 | 0.5072 | 0.373 | 12.4 | 15.24 |
| 20000 | 0.614 | 0.453 | 17.237 | 20.08 |
| 22000 | 0.722 | 0.532 | 26.13 | 28.98 |
| 24000 | 0.83 | 0.611 | 47.05 | 49.9 |
| 26000 | 0.937 | 0.69 | 138.97 | 141.82 |

TABLE 4-B4
Tension (g) 500
P_{core} (psig) 0.14

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.368 | −0.271 | 2.78 | 5.63 |
| 2500 | −0.261 | −0.192 | 3.254 | 6.1 |
| 5000 | −0.153 | −0.113 | 3.82 | 6.66 |
| 7500 | −0.046 | −0.033 | 4.51 | 7.36 |
| 10000 | 0.061 | 0.045 | 5.376 | 8.223 |
| 12500 | 0.1691 | 0.1246 | 6.478 | 9.325 |
| 15000 | 0.276 | 0.203 | 7.92 | 10.77 |
| 17500 | 0.384 | 0.283 | 9.914 | 12.761 |
| 20000 | 0.491 | 0.362 | 12.774 | 15.622 |
| 22500 | 0.599 | 0.441 | 17.207 | 20.05 |
| 25000 | 0.707 | 0.521 | 24.88 | 27.72 |
| 27500 | 0.814 | 0.6 | 40.918 | 43.76 |
| 30000 | 0.922 | 0.679 | 91.22 | 94.07 |

TABLE 5-A

| | |
|---|---|
| Preform Outer Tube OD, 2 × R_{ocp} (mm) | 49.6 |
| Preform Outer Tube ID, 2 × r_{ocp} (mm) | 9 |
| Preform Inner Tube OD, 2 × R_{cp} (mm) | 2 |
| Preform Inner Tube ID, 2 × r_{cp} (mm) | 1.5 |
| Fiber Draw Speed (m/s) | 8.54 |
| Fiber Outer Cladding OD, 2 × R_{ocf} (μm) | 250 |
| Fiber Outer Cladding ID, 2 × r_{ocf} (μm) | 79.7 |

TABLE 5-B1
Tension (g) 400
P_{core} (psig) 0.09

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | | | | |
| 2000 | −0.713 | −0.535 | | |
| 4000 | −0.475 | −0.356 | | |
| 5000 | −0.356 | −0.267 | 0.067 | 2.0117 |
| 6000 | −0.237 | −0.178 | 0.299 | 2.243 |
| 8000 | 0 | 0 | 0.98 | 2.924 |
| 10000 | 0.237 | 0.178 | 2.246 | 4.19 |
| 12000 | 0.475 | 0.356 | 5.24 | 7.19 |
| 14000 | 0.713 | 0.534 | 18.47 | 20.42 |
| 15000 | 0.832 | 0.624 | 81.57 | 83.52 |

TABLE 5-B2
Tension (g) 500
P_{core} (psig) 0.14

| | | | Capillary | Capillary |
|---|---|---|---|---|
| Capillary dP | | | ID in Fiber, | OD in Fiber, |
| (dynes/cm²) | X₁ | X₂ | 2 × r_{cf} (μm) | 2 × R_{cf} (μm) |
| 0 | −0.76 | −0.57 | | |
| 2000 | −0.57 | −0.427 | 0.23 | 2.175 |
| 4000 | −0.38 | −0.285 | 0.559 | 2.5504 |
| 5000 | −0.285 | −0.213 | 0.768 | 2.712 |
| 8000 | 0 | 0 | 1.6896 | 3.634 |
| 10000 | 0.19 | 0.142 | 2.76 | 4.702 |
| 12000 | 0.38 | 0.283 | 4.694 | 6.638 |
| 14000 | 0.57 | 0.427 | 9.029 | 10.97 |
| 15000 | 0.6657 | 0.499 | 13.92 | 15.86 |
| 16000 | 0.76 | 0.57 | 25.29 | 27.29 |
| 17500 | 0.903 | 0.677 | 271.47 | 273.41 |

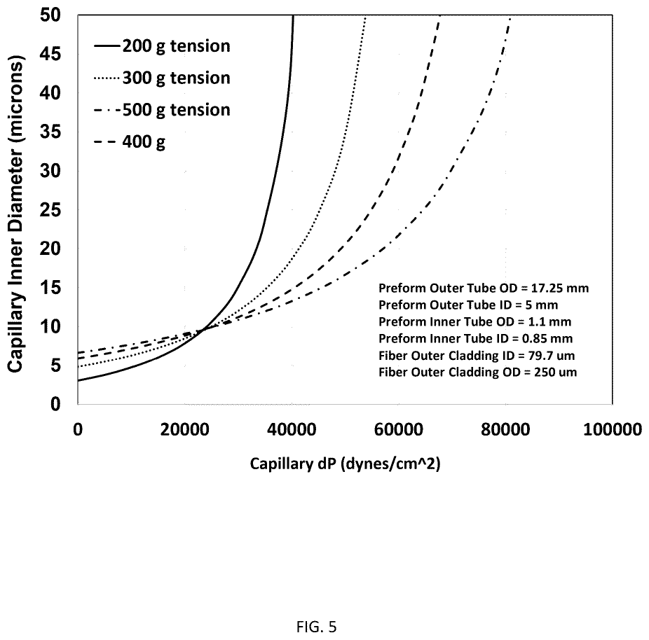

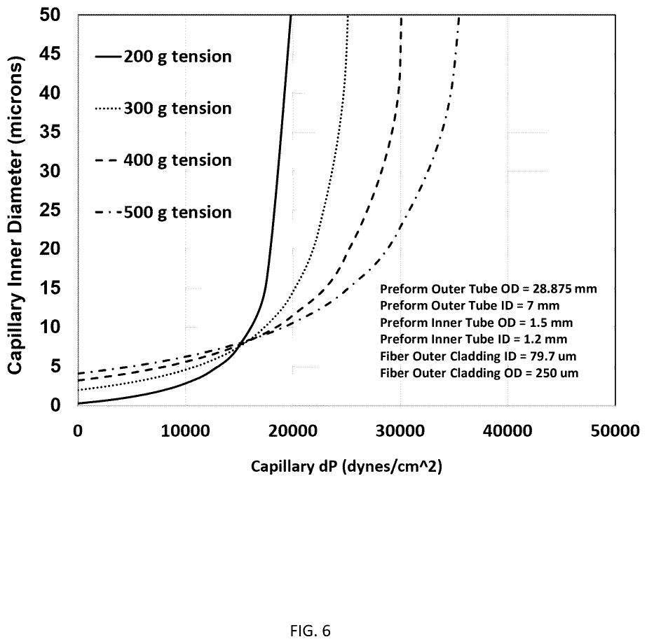

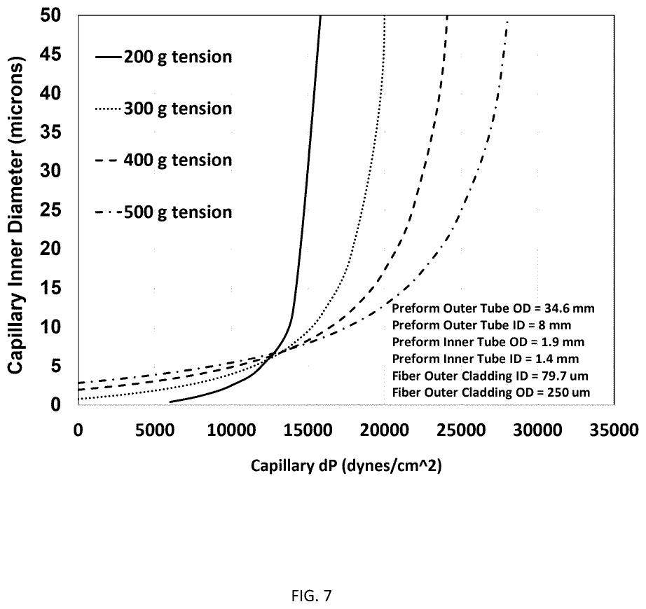

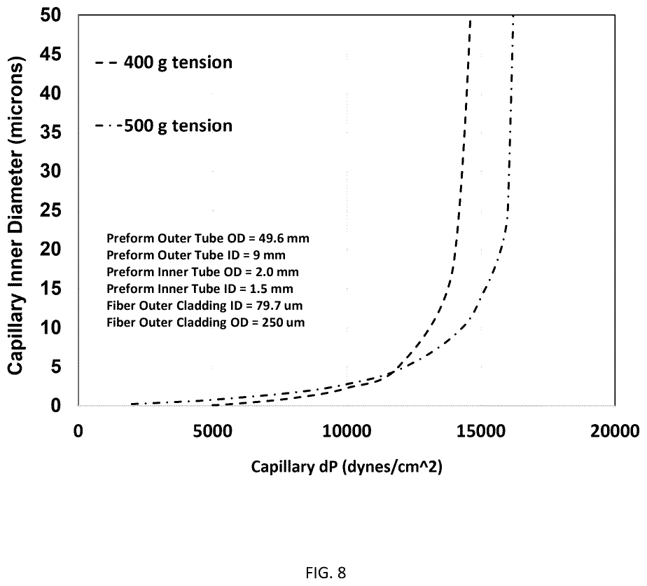

The plots of FIGS. 5-8 show the inner diameter of the capillaries drawn as a function of the differential capillary pressure during the drawing process. The inventor has found that at relatively low differential capillary pressure, a small increase or decrease in the differential capillary pressure may not significantly affect the inner diameter of the capillaries drawn; at relatively high differential capillary pressure, even a small increase or decrease in the differential capillary pressure may result in drastic change in the inner diameter of the capillaries drawn.

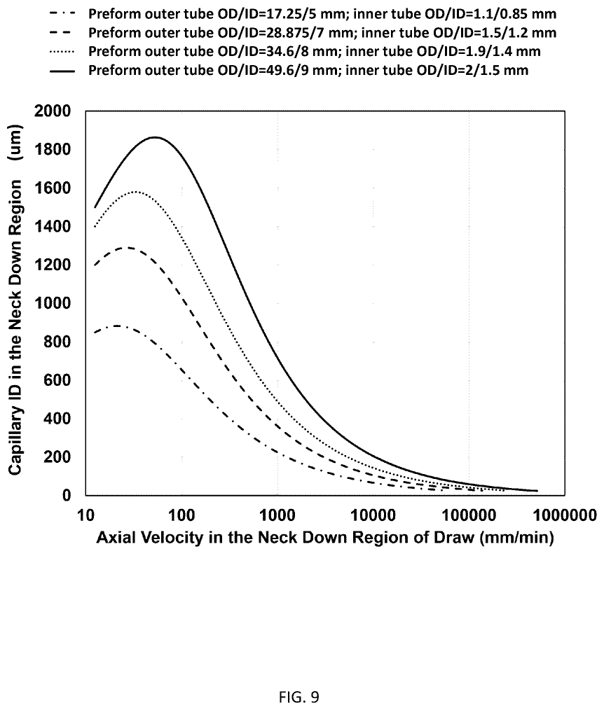

FIG. 9 plots the evolution of the inner diameters of the capillaries from the inner tubes of the hollow-core preform in the neck down region as a function of axial velocity in the neck down region, for the different combinations of preform sizes, draw speeds, and differential capillary pressures outlined in Tables 2-5. As shown, the inner diameter may initially gradually increase as the differential capillary pressure may be the dominant factor affecting the inner diameter. As the tubes are continuously drawn down, the effects of surface tension on the inner diameter may become prominent, in combination with the differential capillary pressure causing the inner diameter to gradually decrease. Thus, the evolution of the inner diameter of the capillaries from the inner diameter of the inner tubers of the hollow-core preform is a complex process. The non-dimensional parameters X₁, X₂, X₃, and/or X₄ described herein provide simplified guidance for selecting the appropriate process condition ranges for drawing hollow-core optical fibers from preforms of different sizes to various desired target capillary dimensions.

### Operating Parameters

The various methods and relations described herein may be implemented with a wide range of operating parameters for scaling up the drawing of hollow-core optical fibers from hollow-core preforms of various sizes while maintaining a tight control over target microstructure dimensions of the hollow-core optical fibers drawn.

### Draw Tension

In some embodiments, the draw tension under which the hollow-core optical fiber may be drawn from a hollow-core preform may be greater than or equal to (i.e., ≥) 50 g and less than or equal to (i.e., ≤) 600 g—including all sub-ranges or values therebetween. For example, in some embodiments, the draw tension may be ≥50 g and ≤600 g, ≥50 g and ≤550 g, ≥50 g and ≤500 g, ≥50 g and ≤450 g, ≥50 g and ≤400 g, ≥50 g and ≤350 g, ≥50 g and ≤300 g, ≥50 g and ≤250 g, ≥50 g and ≤200 g, ≥50 g and ≤150 g, ≥50 g and ≤100 g, ≥100 g and ≤600 g, ≥100 g and ≤550 g, ≥100 g and ≤500 g, ≥100 g and ≤450 g, ≥100 g and ≤400 g, ≥100 g and ≤350 g, ≥100 g and ≤300 g, ≥100 g and ≤250 g, ≥100 g and ≤200 g, ≥100 g and ≤150 g, ≥150 g and ≤600 g, ≥150 g and ≤550 g, ≥150 g and ≤500 g, ≥150 g and ≤450 g, ≥150 g and <400g, ≥150 g and ≤350 g, ≥150 g and ≤300 g, ≥150 g and ≤250 g, ≥150 g and ≤200 g, ≥200 g and ≤600 g, ≥200 g and ≤550 g, ≥200 g and ≤500 g, ≥200 g and ≤450 g, ≥200 g and <400 g, ≥200 g and ≤350 g, ≥200 g and ≤300 g, ≥200 g and ≤250 g, ≥250 g and ≤600 g, ≥250 g and ≤550 g, 250 g and ≤500 g, ≥250 g and ≤450 g, ≥250 g and ≤400 g, ≥250 g and <350 g, ≥250 g and ≤300 g, ≥300 g and ≤600 g, ≥300 g and ≤550 g, ≥300 g and ≤500 g, ≥300 g and ≤450 g, ≥300 g and ≤400 g, ≥300 g and ≤350 g, ≥350 g and ≤600 g, ≥350 g and <550 g, ≥350 g and ≤500 g, ≥350 g and ≤450 g, ≥350 g and ≤400 g, ≥400 g and ≤600 g, ≥400 g and ≤550 g, ≥400 g and ≤500 g, ≥400 g and ≤450 g, ≥450 g and ≤600 g, ≥450 g and ≤550 g, ≥450 g and ≤500 g, ≥500 g and ≤600 g, ≥550 g and ≤600 g, or ≥550 g and ≤600 g.

In some embodiments, the draw tension under which the hollow-core optical fiber may be drawn from a hollow-core preform may be greater than or equal to (i.e., ≥) 50 g, ≥70 g, ≥90 g, ≥110 g, ≥130 g, 150 g, ≥170 g, ≥190 g, ≥210 g, 230 g, 250 g, ≥270 g, 290 g, ≥310 g, 330 g, 350 g, 370 g, 390 g, 410 g, 430 g, 450 g, 470 g, 490 g, ≥510 g, ≥530 g, ≥550 g, ≥570 g, ≥590 g, or greater. In some embodiments, the draw tension under which the hollow-core optical fiber may be drawn from the hollow-core preform may be less than or equal to (i.e., ≤) 600 g, ≤580 g, ≤560 g, ≤540 g, ≤520 g, 500 g, ≤480 g, ≤460 g, ≤440 g, ≤420 g, 400 g, ≤380 g, ≤360 g, ≤340 g, ≤320 g, ≤300 g, ≤280 g, ≤260 g, ≤240 g, ≤220 g, ≤200 g, ≤180 g, ≤160 g, ≤140 g, ≤120 g, ≤100 g, ≤80 g, ≤60 g, or less. Draw Speed

In some embodiments, the hollow-core optical fiber may be drawn at a draw speed of greater than or equal to (i.e., ≥) 1 m/s and less than or equal to (i.e., ≤) 20 m/s—including all sub-ranges or values therebetween. For example, in some embodiments, the draw speed may be ≥1 m/s and ≤20 m/s, ≥1 m/s and ≤15 m/s, ≥1 m/s and ≤10 m/s, ≥1 m/s and ≤5 m/s, ≥5 m/s and ≤20 m/s, ≥5 m/s and ≤15 m/s, ≥5 m/s and ≤10 m/s, ≥10 m/s and ≤20 m/s, ≥10 m/s and ≤15 m/s, or ≥15 m/s and ≤20 m/s. In some embodiments, the hollow-core optical fiber may be drawn at a draw speed of greater than or equal to (i.e., ≥) 1 m/s, ≥3 m/s, ≥5 m/s, ≥7 m/s, ≥9 m/s, ≥11 m/s, ≥13 m/s, ≥15 m/s, ≥17 m/s, ≥19 m/s, or greater.

### Preform Feed Rate

In some embodiments, the hollow-core preform may be fed into the draw furnace at a preform feed rate Vₚ that may be greater than or equal to (i.e., ≥) 5 mm/min and less than or equal to (i.e., ≤) 100 mm/min—including all sub-ranges or values therebetween. For example, in some embodiments, the hollow-core preform may be fed into the draw furnace at a preform feed rate Vₚ that may be ≥5 mm/min and ≤100 mm/min, ≥5 mm/min and ≤75 mm/min, ≥5 mm/min and ≤50 mm/min, ≥5 mm/min and ≤25 mm/min, ≥25 mm/min and ≤100 mm/min, ≥25 mm/min and ≤75 mm/min, ≥25 mm/min and ≤50 mm/min, ≥50 mm/min and ≤100 mm/min, ≥50 mm/min and ≤75 mm/min, or ≥75 mm/min and ≤100 mm/min. In some embodiments, the hollow-core preform may be fed into the draw furnace at a preform feed rate Vₚ that may be ≥5 mm/min, ≥10 mm/min, ≥15 mm/min, ≥20 mm/min, ≥25 mm/min, ≥30 mm/min, ≥35 mm/min, ≥40 mm/min, ≥45 mm/min, ≥50 mm/min, ≥55 mm/min, ≥60 mm/min, ≥65 mm/min, ≥70 mm/min, ≥75 mm/min, ≥80 mm/min, ≥85 mm/min, ≥90 mm/min, ≥95 mm/min, or greater. In some embodiments, the hollow-core preform may be fed into the draw furnace at a preform feed rate Vₚ that may be less than or equal to 100 mm/min, ≤95 mm/min, ≤90 mm/min, ≤85 mm/min, ≤80 mm/min, ≤75 mm/min, ≤70 mm/min, ≤65 mm/min, ≤60 mm/min, ≤55 mm/min, ≤50 mm/min, ≤45 mm/min, ≤40 mm/min, ≤35 mm/min, ≤30 mm/min, ≤25 mm/min, ≤20 mm/min, ≤15 mm/min, ≤10 mm/min, or less.

### Differential Core Pressure P_{core}

In some embodiments, the differential core pressure P_{core} may be greater than or equal to (i.e., ≥) 0.01 psig and less than or equal to (i.e., ≤) 2 psig—including all sub-ranges or values therebetween. For example, in some embodiments, the differential core pressure P_{core} may be may be ≥0.01 psig and ≤2 psig, ≥0.01 psig and ≤1.5, ≥0.01 psig and ≤1, ≥0.01 psig and <0.5, ≥0.01 psig and ≤0.1 psig, ≥0.1 psig and ≤2 psig, ≥0.1 psig and ≤1.5, ≥0.1 psig and ≤1, ≥0.1 psig and ≤0.5, ≥0.5 psig and ≤2 psig, ≥0.5 psig and ≤1.5, ≥0.5 psig and ≤1, ≥1 psig and ≤2 psig, ≥1 psig and ≤1.5, or ≥1.5 psig and ≤2 psig.

In some embodiments, the differential core pressure P_{core} may be greater than or equal to (i.e., ≥) 0.01 psig, ≥0.05 psig, ≥0.1 psig, ≥0.2 psig, ≥0.3 psig, ≥0.4 psig, ≥0.5 psig, ≥0.6 psig, ≥0.7 psig, ≥0.8 psig, ≥0.9 psig, ≥1 psig, ≥1.1 psig, ≥1.2 psig, ≥1.3 psig, ≥1.4 psig, ≥1.5 psig, ≥1.6 psig, ≥1.7 psig, ≥1.8 psig, ≥1.9 psig, or greater. In some embodiments, the differential core pressure P_{core} may be less than or equal to (i.e., ≤) 2 psig, ≤1.9 psig, ≤1.8 psig, ≤1.7 psig, ≤1.6 psig, ≤1.5 psig, ≤1.4 psig, ≤1.3 psig, ≤1.2 psig, ≤1.1 psig, ≤1 psig, ≤0.9 psig, ≤0.8 psig, ≤0.7 psig, ≤0.6 psig, ≤0.5 psig, ≤0.4 psig, ≤0.3 psig, ≤0.2 psig, ≤0.1 psig, ≤0.05 psig, or less.

Differential Capillary Pressure ΔP_{c}

In some embodiments, the differential capillary pressure ΔP_{c} may be greater than or equal to (i.e., ≥) 5,000 dynes/cm² and less than or equal to (i.e., ≤) 100,000 dynes/cm² —including all sub-ranges or values therebetween. For example, in some embodiments, the differential capillary pressure ΔP_{c} may be ≥5,000 dynes/cm² and ≤100,000 dynes/cm², ≥5,000 dynes/cm² and ≤75,000 dynes/cm², ≥5,000 dynes/cm² and ≤50,000 dynes/cm², ≥5,000 dynes/cm² and K 25,000 dynes/cm², ≥5,000 dynes/cm² and K 10,000 dynes/cm², ≥10,000 dynes/cm² and K 100,000 dynes/cm², ≥10,000 dynes/cm² and K 75,000 dynes/cm², ≥10,000 dynes/cm² and K 50,000 dynes/cm², ≥10,000 dynes/cm² and K 25,000 dynes/cm², ≥25,000 dynes/cm² and K 100,000 dynes/cm², ≥25,000 dynes/cm² and K 75,000 dynes/cm², ≥25,000 dynes/cm² and K 50,000 dynes/cm², ≥50,000 dynes/cm² and K 100,000 dynes/cm², ≥50,000 dynes/cm² and K 75,000 dynes/cm², or ≥75,000 dynes/cm² and K 100,000 dynes/cm².

In some embodiments, the differential capillary pressure ΔP_{c} may be greater than or equal to (i.e., ≥) 5,000 dynes/cm², ≥10,000 dynes/cm², ≥15,000 dynes/cm², ≥20,000 dynes/cm², ≥25,000 dynes/cm², ≥30,000 dynes/cm², ≥35,000 dynes/cm², ≥40,000 dynes/cm², ≥45,000 dynes/cm², ≥50,000 dynes/cm², ≥55,000 dynes/cm², ≥60,000 dynes/cm², ≥65,000 dynes/cm², ≥70,000 dynes/cm², ≥75,000 dynes/cm², ≥80,000 dynes/cm², ≥85,000 dynes/cm², ≥90,000 dynes/cm², ≥95,000 dynes/cm², or greater.

In some embodiments, the differential capillary pressure ΔP_{c} may be less than or equal to (i.e., ≤) 100,000 dynes/cm², ≤95,000 dynes/cm², ≤90,000 dynes/cm², ≤85,000 dynes/cm², ≤80,000 dynes/cm², ≤75,000 dynes/cm², ≤70,000 dynes/cm², ≤65,000 dynes/cm², ≤60,000 dynes/cm², ≤55,000 dynes/cm², ≤50,000 dynes/cm², ≤45,000 dynes/cm², ≤40,000 dynes/cm², ≤35,000 dynes/cm², ≤30,000 dynes/cm², ≤25,000 dynes/cm², ≤20,000 dynes/cm², ≤15,000 dynes/cm², ≤10,000 dynes/cm², or less.

### Differential Nested Capillary Pressure ΔP_{nc}

In some embodiments, the differential nested capillary pressure ΔP_{nc} may be greater than or equal to (i.e., ≥) 2,000 dynes/cm² and less than or equal to (i.e., ≤) 50,000 dynes/cm²-including all sub-ranges or values therebetween. For example, in some embodiments, the differential nested capillary pressure ΔP_{nc} may be ≥2,000 dynes/cm² and K 50,000 dynes/cm², ≥2,000 dynes/cm² and K 40,000 dynes/cm², ≥2,000 dynes/cm² and K 30,000 dynes/cm², ≥2,000 dynes/cm² and K 20,000 dynes/cm², ≥2,000 dynes/cm² and K 10,000 dynes/cm², ≥10,000 dynes/cm² and K 50,000 dynes/cm², ≥10,000 dynes/cm² and K 40,000 dynes/cm², ≥10,000 dynes/cm² and K 30,000 dynes/cm², ≥10,000 dynes/cm² and K 20,000 dynes/cm², ≥20,000 dynes/cm² and K 50,000 dynes/cm², ≥20,000 dynes/cm² and K 40,000 dynes/cm², ≥20,000 dynes/cm² and K 30,000 dynes/cm², ≥30,000 dynes/cm² and ≤50,000 dynes/cm², ≥30,000 dynes/cm² and K 40,000 dynes/cm², or ≥40,000 dynes/cm² and K 50,000 dynes/cm².

In some embodiments, the differential nested capillary pressure ΔP_{nc} may be greater than or equal to (i.e., ≥) 2,000 dynes/cm², ≥5,000 dynes/cm², ≥10,000 dynes/cm², ≥15,000 dynes/cm², ≥20,000 dynes/cm², ≥25,000 dynes/cm², ≥30,000 dynes/cm², ≥35,000 dynes/cm², ≥40,000 dynes/cm², ≥45,000 dynes/cm², or greater. In some embodiments, the differential nested capillary pressure ΔP_{nc} may be less than or equal to (i.e., ≤) 50,000 dynes/cm², K 45,000 dynes/cm², K 40,000 dynes/cm², K 35,000 dynes/cm², K 30,000 dynes/cm², K 25,000 dynes/cm², K 20,000 dynes/cm², K 15,000 dynes/cm², K 10,000 dynes/cm², K 5,000 dynes/cm², or less.

### Preform Outer Tube Dimesions

In some embodiments, the inner diameter of the outer tube of the hollow-core preform (2×r_{ocp}) may be greater than or equal to (i.e., ≥) 4 mm and less than or equal to (i.e., ≤) 20 mm—including all sub-ranges or values therebetween. For example, in some embodiments, the inner diameter of the outer tube of the hollow-core preform (2×r_{ocp}) may be ≥4 mm and K 20 mm, ≥4 mm and ≤16 mm, ≥4 mm and ≤12 mm, ≥4 mm and 8 mm, ≥8 mm and ≤20 mm, ≥8 mm and ≤16 mm, ≥8 mm and ≤12 mm, ≥12 mm and ≤20 mm, ≥12 mm and ≤16 mm, or ≥16 mm and ≤20 mm. In some embodiments, the inner diameter of the outer tube of the hollow-core preform (2×r_{ocp}) may be greater than or equal to (i.e., ≥) 4 mm, ≥5 mm, ≥6 mm, ≥7 mm, ≥8 mm, ≥9 mm, ≥10 mm, 11 mm, ≥12 mm, ≥13 mm, ≥14 mm, ≥15 mm, ≥16 mm, ≥17 mm, ≥18 mm, ≥19 mm, or greater. In some embodiments, the inner diameter of the outer tube of the hollow-core preform (2×r_{ocp}) may be less than or equal to (i.e., ≤) 20 mm, ≤19 mm, ≤18 mm, ≤17 mm, ≤16 mm, ≤15 mm, ≤14 mm, ≤13 mm, ≤12 mm, ≤11 mm, ≤10 mm, ≤9 mm, ≤8 mm, ≤7 mm, ≤6 mm, ≤5 mm, or less.

In some embodiments, the outer diameter of the outer tube of the hollow-core preform (2×R_{ocp}) may be greater than or equal to (i.e., ≥) 15 mm and less than or equal to (i.e., ≤) to 100 mm—including all sub-ranges or values therebetween. For example, in some embodiments, the outer diameter of the outer tube of the hollow-core preform (2×R_{ocp}) may be ≥15 mm and ≤100 mm, ≥15 mm and ≤75 mm, ≥15 mm and ≤50 mm, ≥15 mm and ≤25 mm, ≥25 mm and ≤100 mm, ≥25 mm and ≤75 mm, ≥25 mm and ≤50 mm, ≥50 mm and ≤100 mm, ≥50 mm and ≤75 mm, or ≥75 mm and ≤100 mm. In some embodiments, the outer diameter of the outer tube of the hollow-core preform (2×R_{ocp}) may be greater than or equal to (i.e., ≥) 15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In some embodiments, the outer diameter of the outer tube of the hollow-core preform (2×R_{ocp}) may be less than or equal to (i.e., ≤) 100 mm, K 95 mm, ≤90 mm, K 85 mm, ≤80 mm, K 75 mm, ≤70 mm, K 65 mm, K 60 mm, ≤55 mm, K 50 mm, K 45 mm, K 40 mm, K 35 mm, K 30 mm, K 25 mm, ≤20 mm, or less.

### Preform Inner Tube Dimensions

In some embodiments, the inner diameter of the inner tube of the hollow-core preform (2×r_{cp}) may be greater than or equal to (i.e., ≥) 1 mm and less than or equal to (i.e., ≤) 8 mm—including all sub-ranges or values therebetween. For example, in some embodiments, the inner diameter of the inner tube of the hollow-core preform (2×r_{cp}) may be ≥1 mm and ≤8 mm, ≥1 mm and ≤6 mm, ≥1 mm and ≤4 mm, ≥1 mm and ≤2 mm, ≥2 mm and ≤8 mm, ≥2 mm and ≤6 mm, ≥2 mm and K 4 mm, ≥4 mm and ≤8 mm, ≥4 mm and ≤6 mm, or ≥6 mm and K 8 mm. In some embodiments, the inner diameter of the inner tube of the hollow-core preform (2×r_{cp}) may be greater than or equal to (i.e., ≥) 1 mm, ≥1.5 mm, ≥2 mm, ≥2.5 mm, ≥3 mm, ≥3.5 mm, ≥4 mm, ≥4.5 mm, ≥5 mm, ≥5.5 mm, ≥6 mm, ≥6.5 mm, ≥7 mm, ≥7.5 mm, or greater. In some embodiments, the inner diameter of the inner tube of the hollow-core preform (2×r_{cp}) may be less than or equal to (i.e., ≤) 8 mm, ≤7.5 mm, ≤7 mm, ≤6.5 mm, ≤6 mm, ≤5.5 mm, ≤5 mm, ≤4.5 mm, ≤4 mm, ≤3.5 mm, ≤3 mm, ≤2.5 mm, ≤2 mm, ≤1.5 mm, or less.

In some embodiments, the outer diameter of the inner tube of the hollow-core preform (2×R_{cp}) may be greater than or equal to (i.e., ≥) 1.4 mm and less than or equal to (i.e., ≤) 10 mm—including all sub-ranges or values therebetween. For example, in some embodiments, in some embodiments, the outer diameter of the inner tube of the hollow-core preform (2×R_{cp}) may be ≥1.4 mm and ≤10 mm, ≥1.4 mm and ≤8 mm, ≥1.4 mm and ≤6 mm, ≥1.4 mmand≤4 mm, or ≥1.4 μm and ≤2 mm. In some embodiments, the outer diameter of the inner tube of the hollow-core preform (2×R_{cp}) may be greater than or equal to (i.e., ≥) 1.4 mm, ≥1.5 mm, ≥2 mm, ≥2.5 mm, ≥3 mm, ≥3.5 mm, ≥4 mm, ≥4.5 mm, ≥5 mm, ≥5.5 mm, ≥6 mm, ≥6.5 mm, ≥7 mm, ≥7.5 mm, ≥8 mm, ≥8.5 mm, ≥9 mm, ≥9.5 mm, or greater. In some embodiments, the outer diameter of the inner tube of the hollow-core preform (2×R_{cp}) may be less than or equal to (i.e., ≤) 10 mm, ≤9.5 mm, ≤9 mm, ≤8.5 mm, ≤8 mm, ≤7.5 mm, ≤7 mm, ≤6.5 mm, 6 mm, ≤5.5 mm, ≤5 mm, ≤4.5 mm, ≤4 mm, ≤3.5 mm, ≤3 mm, ≤2.5 mm, ≤2 mm, ≤1.5 mm, or less.

### Preform Nested Tube Dimensions

In some embodiments, the inner diameter of the nested tube of the hollow-core preform (2×r_{ncp}) may be greater than or equal to (i.e., ≥) 0.5 mm and less than or equal to (i.e., ≤) 1.3 mm—including all sub-ranges or values therebetween. For example, in some embodiments, the inner diameter of the nested tube of the hollow-core preform (2×r_{ncp}) may be ≥0.5 mm and <1.3 mm, ≥0.5 mm and ≤1.1 mm, ≥0.5 mm and ≤0.9 mm, ≥0.5 mm and ≤0.7 mm, ≥0.7 mm and ≤1.3 mm, ≥0.7 mm and ≤1.1 mm, ≥0.7 mm and ≤0.9 mm, ≥0.9 mm and ≤1.3 mm, ≥0.9 mm and ≤1.1 mm, or ≥1.1 mm and ≤1.3 mm. In some embodiments, the inner diameter of the nested tube of the hollow-core preform (2×r_{ncp}) may be greater than or equal to (i.e., ≥) 0.5 mm, ≥0.6 mm, ≥0.7 mm, ≥0.8 mm, ≥0.9 mm, ≥1 mm, ≥1.1 mm, ≥1.2 mm, or greater. In some embodiments, the inner diameter of the nested tube of the hollow-core preform (2×rnₑp) may be less than or equal to (i.e., ≤) 1.3 mm, ≤1.2 mm, ≤1.1 mm, ≤1 mm, ≤0.9 mm, ≤0.8 mm, ≤0.7 mm, ≤0.6 mm, or less.

In some embodiments, the outer diameter of the nested tube of the hollow-core preform (2×R_{ncp}) may be greater than or equal to (i.e., ≥) 0.6 mm and less than or equal to (i.e.,≤) to 1.5 mm—including all sub-ranges or values therebetween. For example, in some embodiments, the outer diameter of the nested tube of the hollow-core preform (2×R_{ncp}) may be ≥0.6 mm and ≤1.5 mm, ≥0.6 mm and ≤1.3 mm, ≥0.6 mm and ≤1.1 mm, ≥0.6 mm and ≤0.9 mm, ≥0.6 mm and ≤0.7 mm, ≥0.8 mm and ≤1.5 mm, ≥0.8 mm and ≤1.3 mm, ≥0.8 mm and <1.1 mm, ≥0.8 mm and ≤0.9 mm, ≥1 mm and ≤1.5 mm, ≥1 mm and ≤1.3 mm, ≥1 mm and <1.1 mm, ≥1.2 mm and ≤1.5 mm, ≥1.2 mm and ≤1.3 mm, or ≥1.4 mm and ≤1.5 mm. In some embodiments, the outer diameter of the nested tube of the hollow-core preform (2×R_{ncp}) may be greater than or equal to (i.e., ≥) 0.6 mm, ≥0.7 mm, ≥0.8 mm, ≥0.9 mm, ≥1 mm, ≥1.1 mm, ≥1.2 mm, ≥1.3 mm, ≥1.4 mm, or greater. In some embodiments, the outer diameter of the nested tube of the hollow-core preform (2×R_{ncp}) may be less than or equal to (i.e., ≤) 1.5 mm, ≤1.4 mm, ≤1.3 mm, ≤1.2 mm, ≤1.1 mm, ≤1 mm, ≤0.9 mm, ≤0.8 mm, ≤0.7 mm, or less.

### Fiber Outer Cladding Dimensions

In some embodiments, the inner diameter of the outer cladding of the hollow-core optical fiber (2×r_{ocf}) may be greater than or equal to (i.e., ≥) 45 μm and less than or equal to (i.e., ≤) 135 μm—including all sub-ranges or values therebetween. For example, in some embodiments, the inner diameter of the outer cladding of the hollow-core optical fiber (2×r_{oc}f) may be ≥45 μm and ≤135 μm, ≥45 μm and ≤115 μm, ≥45 μm and ≤95 μm, ≥45 μm and <75 μm, ≥45 μm and ≤55 μm, ≥55 μm and ≤135 μm, ≥55 μm and ≤115 μm, ≥55 μm and ≤95 μm, ≥55 μm and ≤75 μm, ≥75 μm and ≤135 μm, ≥75 μm and ≤115 μm, ≥75 μm and ≤95 μm, ≥95 μm and ≤135 μm, ≥95 μm and ≤115 μm, or ≥115 μm and ≤135 μm. In some embodiments, the inner diameter of the outer cladding of the hollow-core optical fiber (2×r_{oc}f) may be greater than or equal to (i.e., ≥) 45 μm, ≥50 mm, ≥55 mm, ≥60 mm, ≥65 mm, ≥70 mm, ≥75 mm, ≥80 mm, ≥85 mm, ≥90 mm, ≥95 mm, ≥100 mm, ≥105 mm, ≥110 mm, ≥115 mm, ≥120 mm, ≥125 mm, ≥130 μm, or greater. In some embodiments, the inner diameter of the outer cladding of the hollow-core optical fiber (2×r_{oc}f) may be less than or equal to (i.e., ≤) 135 μm, ≤130 μm, ≤125 μm, ≤120 μm, ≤115 μm, ≤110 μm, ≤105 μm, ≤100 μm, ≤95 μm, ≤90 μm, ≤85 μm, ≤80 μm, ≤75 μm, ≤70 μm, ≤65 μm, ≤60 μm, ≤55 μm, ≤50 μm, or less.

In some embodiments, the outer diameter of the outer cladding of the hollow-core optical fiber (2×R_{ocf}) may be greater than or equal to (i.e., ≥) 150 μm and less than or equal to (i.e., ≤) 300 μm—including all sub-ranges or values therebetween. For example, in some embodiments, the outer diameter of the outer cladding of the hollow-core optical fiber (2×R_{ocf}) may be ≥150 μm and ≤300 μm, ≥150 μm and ≤250 μm, ≥150 μm and ≤200 μm, ≥200 μm and ≤300 μm, ≥200 μm and ≤250 μm, or ≥250 μm and ≤300 μm. In some embodiments, the outer diameter of the outer cladding of the hollow-core optical fiber (2×R_{ocf}) may be greater than or equal to (i.e., ≥) 150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, or greater. In some embodiments, the outer diameter of the outer cladding of the hollow-core optical fiber (2×R_{ocf}) may be less than or equal to (i.e., ≤) 300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, or less.

### Fiber Capillary Dimensions

In some embodiments, the inner diameter of the capillaries of the hollow-core optical fiber (2×r_{cf}) may be greater than or equal to (i.e., ≥) 10 μm and less than or equal to (i.e., ≤) 40 μm—including all sub-ranges or values therebetween. For example, in some embodiments, the inner diameter of the capillaries of the hollow-core optical fiber (2×r_{cf}) may be ≥10 μm and <40 μm, ≥10 μm and ≤30 μm, ≥10 μm and ≤20 μm, ≥20 μm and ≤40 μm, ≥20 and ≤30 μm, or ≥30 μm and ≤40 μm. In some embodiments, the inner diameter of the capillaries of the hollow-core optical fiber (2×r_{c}f) may be greater than or equal to (i.e., ≥) 10 μm, ≥12.5 μm, ≥15 μm, ≥17.5 μm, ≥20 μm, ≥22.5 μm, ≥25 μm, ≥27.5 μm, ≥30 μm, ≥32.5 μm, ≥35 μm, ≥37.5 μm, or greater. In some embodiments, the inner diameter of the capillaries of the hollow-core optical fiber (2×r_{cf}) may be less than or equal to (i.e., ≤) 40 μm, ≤37.5 μm, ≤35 μm, ≤32.5 μm, ≤30 μm, ≤27.5 μm, ≤25 μm, ≤22.5 μm, ≤20 μm, ≤17.5 μm, ≤15 μm, ≤12.5 μm, or less.

In some embodiments, the outer diameter of the capillaries of the hollow-core optical fiber (2×R_{cf}) may be greater than or equal to (i.e., ≥) 14 μm and less than or equal to (i.e., ≤) 50 μm—including all sub-ranges or values therebetween. For example, in some embodiments, the outer diameter of the capillaries of the hollow-core optical fiber (2×R_{cf}) may be ≥14 μm and <50 μm, ≥14 μm and ≤40 μm, ≥14 μm and ≤30 μm, ≥14 μm and ≤20 μm, ≥20 μm and ≤50 μm, ≥20 μm and ≤40 μm, ≥20 μm and ≤30 μm, ≥30 μm and ≤50 μm, ≥30 μm and ≤40 μm, or ≥40 μm and ≤50 μm. In some embodiments, the outer diameter of the capillaries of the hollow-core optical fiber (2×Ref) may be greater than or equal to (i.e., ≥) 14 μm, ≥15 μm, ≥17.5 μm, ≥20 μm, ≥22.5 μm, ≥25 μm, ≥27.5 μm, ≥30 μm, ≥32.5 μm, ≥35 μm, ≥37.5 μm, ≥40 μm, ≥42.5 μm, ≥45 μm, ≥47.5 μm, or greater. In some embodiments, the outer diameter of the capillaries of the hollow-core optical fiber (2×Ref) may be less than or equal to (i.e., ≤) 50 μm, ≤47.5 μm, ≤45 μm, ≤42.5 μm, ≤40 μm, ≤37.5 μm, ≤35 μm, ≤32.5 μm, ≤30 μm, ≤27.5 μm, ≤25 μm, ≤22.5 μm, ≤20 μm, ≤17.5 μm, 15 μm, orless.

### Fiber Nested Capillary Dimesions

In some embodiments, the inner diameter of the nested capillaries of the hollow-core optical fiber (2×r_{ncf}) may be greater than or equal to (i.e., ≥) 10 μm and less than or equal to (i.e., ≤) 28 μm—including all sub-ranges or values therebetween. For example, in some embodiments, the inner diameter of the nested capillaries of the hollow-core optical fiber (2×r_{ncf}) may be ≥10 μm and ≤28 μm, ≥10 μm and ≤24 μm, ≥10 μm and ≤20 μm, ≥10 μm and ≤16 μm, ≥10 μm and ≤12 μm, ≥14 μm and ≤28 μm, ≥14 μm and ≤24 μm, ≥14 μm and ≤20 μm, ≥14 μm and ≤16 μm, ≥18 μm and ≤28 μm, ≥18 μm and ≤24 μm, ≥18 μm and ≤20 μm, ≥22 μm and ≤28 μm, ≥22 μm and ≤24 μm, or ≥26 μm and ≤28 μm. In some embodiments, the inner diameter of the nested capillaries of the hollow-core optical fiber (2×r_{ncf}) may be greater than or equal to (i.e., ≥) 10 μm, ≥11 μm, ≥12 μm, ≥13 μm, ≥14 μm, ≥15 μm, ≥16 μm, ≥17 μm, ≥18 μm, ≥19 μm, ≥20 μm, ≥21 μm, ≥22 μm, ≥23 μm, ≥24 μm, ≥25 μm, ≥26 μm, ≥27 μm, or greater. In some embodiments, the inner diameter of the nested capillaries of the hollow-core optical fiber (2×r_{ncf}) may be less than or equal to (i.e., ≤) 28 μm, ≤27 μm, ≤26 μm, ≤25 μm, ≤24 μm, ≤23 μm, ≤§ 22 μm, ≤§ 21 μm, ≤§ 20 μm, ≤§ 19 μm, ≤§ 18 μm, ≤§ 17 μm, ≤§ 16 μm, ≤15 μm, ≤14 μm, ≤13 μm, ≤12 μm, ≤11 μm, or less.

In some embodiments, the outer diameter of the nested capillaries of the hollow-core optical fiber (2×R_{ncf}) may be greater than or equal to (i.e., ≥) 11 μm and less than or equal to (i.e., ≤) 30 μm—including all sub-ranges or values therebetween. For example, in some embodiments, the outer diameter of the nested capillaries of the hollow-core optical fiber (2×R_{ncf}) may be ≥11 μm and ≤30 μm, ≥11 μm and ≤25 μm, ≥11 μm and ≤20 μm, ≥11 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In some embodiments, the outer diameter of the nested capillaries of the hollow-core optical fiber (2×R_{ncf}) may be greater than or equal to (i.e., ≥) 11 μm, ≥12 μm, ≥13 μm, ≥14 μm, ≥15 μm, ≥16 μm, ≥17 μm, ≥18 μm, ≥19 m, ≥20 μm, 21 μm, ≥22 μm, ≥23 μm, ≥24 μm, ≥25 μm, ≥26 μm, ≥27 μm, ≥28 μm, ≥29 μm, or greater. In some embodiments, the outer diameter of the nested capillaries of the hollow-core optical fiber (2×R_{ncf}) may be less than or equal to (i.e., ≤) 30 m, ≤29 μm, ≤28 μm, ≤27 μm, ≤26 μm, ≤25 μm, 24 μm, 23 μm, 22 μm, 21 μm, ≤20 μm, ≤19 μm, ≤18 μm, ≤17 μm, ≤16 μm, ≤15 μm, ≤14 μm, ≤13 μm, ≤12 μm, or less.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of producing a hollow-core optical fiber from a hollow-core preform, the method comprising:
heating a hollow-core preform comprising an outer tube and an inner tube, wherein the outer tube comprises an inner surface defining an interior cavity and an inner radius r_{ocp} and an outer surface defining an outer radius R_{ocp}, wherein the inner tube comprises an inner surface defining an interior cavity and an inner radius r_{cp} and an outer surface defining an outer radius R_{cp}, wherein the inner tube is formed from a glass material; and
drawing a hollow-core optical fiber from the hollow-core preform at a draw tension T_{g} in grams, thereby elongating the outer tube of the hollow-core preform into an outer cladding of the hollow-core optical fiber and elongating the inner tube of the hollow-core preform into a capillary of the hollow-core optical fiber, wherein the draw tension T_{g} and a differential capillary pressure Δp_{c} are selected at least in part based on a non-dimensional parameter X₁, wherein the differential capillary pressure Δp_{c} is defined as a difference between a pressure inside the interior cavity of the inner tube of the hollow-core preform and a pressure inside the interior cavity of the outer tube of the hollow-core preform, wherein X₁ is defined as:
$${X}_{1} = \frac{3 π ( {R}_{ocp}^{2} - {r}_{ocp}^{2} ) {R}_{cp} ( Δ {p}_{c} {r}_{cp} - 2 {σ}_{c} )}{4 T {r}_{cp} ( {R}_{cp} - {r}_{cp} )} ,$$
where:
T is the draw tension in dynes, and T=981×T_{g};
Δp_{c} is in dynes/cm²; and
σ_{c} in dyne/cm is a surface energy of the glass material forming the inner tube; and
wherein X₁ is greater than or equal to −0.5 and less than or equal to 0.75.

2. The method of claim 1, wherein the non-dimensional parameter X₁ is greater than or equal to 0 and less than or equal to 0.7.

3. The method of claim 1, wherein the non-dimensional parameter X₁ is greater than or equal to 0.25 and less than or equal to 0.65.

4. The method of claim 1, wherein the draw tension T_{g} and the differential capillary pressure Δp_{c} are selected at least in part further based on a non-dimensional parameter X₂, wherein X₂ is defined as:
$${X}_{2} = \frac{3 π ( {R}_{ocp}^{2} - {r}_{ocp}^{2} ) {r}_{cp} ( Δ {p}_{c} {R}_{cp} - 2 {σ}_{c} )}{4 T {R}_{cp} ( {R}_{cp} - {r}_{cp} )} ,$$
wherein X₂ is greater than or equal to −0.35 and less than or equal to 0.6.

5. The method of claim 4, wherein the non-dimensional parameter X₂ is greater than or equal to 0 and less than or equal to 0.55.

6. The method of claim 4, wherein the non-dimensional parameter X₂ is greater than or equal to 0.18 and less than or equal to 0.5.

7. The method of claim 1, wherein:
the hollow-core preform further comprises a nested tube in contact with an inner surface of the inner tube of the hollow-core preform, and wherein the nested tube comprises an inner surface defining an interior cavity and an inner radius r_{ncp} and an outer surface defining an outer radius R_{ncp};
the drawing further elongates the nested tube of the hollow-core preform to a nested capillary of the hollow-core optical fiber; and
the draw tension T_{g} and a differential capillary pressure Δp_{nc} are selected at least in part based on a non-dimensional parameter X₃, wherein the differential nested capillary pressure Δp_{nc} is defined as a difference between a pressure inside the interior cavity of the nested tube of the hollow-core preform and a pressure inside the interior cavity of the outer tube of the hollow-core preform, wherein X₃ is defined as:
$${X}_{3} = \frac{3 π ( {R}_{ocp}^{2} - {r}_{ocp}^{2} ) {R}_{ncp} ( Δ {p}_{nc} {r}_{ncp} - 2 {σ}_{nc} )}{4 T {r}_{ncp} ( {R}_{ncp} - {r}_{ncp} )} ,$$
where σ_{nc} is the surface energy of a glass material forming the nested tube;
wherein X₃ is greater than or equal to −0.5 and less than or equal to 0.75.

8. The method of claim 7, wherein the non-dimensional parameter X₃ is greater than or equal to 0 and less than or equal to 0.7.

9. The method of claim 7, wherein the non-dimensional parameter X₃ is greater than or equal to 0.25 and less than or equal to 0.65.

10. The method of claim 7, wherein the draw tension T_{g} and the differential capillary pressure Δp_{nc} are selected at least in part further based on a non-dimensional parameter X₄, wherein X₄ is defined as:
$${X}_{4} = \frac{3 π ( {R}_{ocp}^{2} - {r}_{ocp}^{2} ) {r}_{ncp} ( Δ {p}_{nc} {R}_{ncp} - 2 {σ}_{nc} )}{4 T {R}_{ncp} ( {R}_{ncp} - {r}_{ncp} )} ,$$
wherein X₄ is greater than or equal to −0.35 and less than or equal to 0.6.

11. The method of claim 10, wherein the non-dimensional parameter X₄ is greater than or equal to 0 and less than or equal to 0.55.

12. The method of claim 10, wherein the non-dimensional parameter X₄ is greater than or equal to 0.18 and less than or equal to 0.5.

13. The method of claim 7, wherein the differential nested capillary pressure Δp_{nc} is greater than or equal to 2,000 dynes/cm² and less than or equal to 50,000 dynes/cm².

14. The method of claim 1, wherein:
a fiber draw speed is greater than or equal to 1 m/s and less than or equal to 20 m/s; and/or
a preform feed rate is greater than or equal to 5 mm/min and less than or equal to 100 mm/min.

15. The method of claim 1, wherein the outer tube of the hollow-core preform satisfies at least one of the following:
wherein the outer radius R_{ocp} of the outer tube of the hollow-core preform is greater than or equal to 7.5 mm and less than or equal to 50 mm; or
wherein the inner radius r_{ocp} of the outer tube of the hollow-core preform is greater than or equal to 2 mm and less than or equal to 10 mm.

16. The method of claim 1, the inner tube of the hollow-core preform satisfies at least one of:
wherein the outer radius R_{c} of the inner tube of the hollow-core preform is greater than or equal to 0.7 mm and less than or equal to 5 mm; or
wherein the inner radius r_{c} of the inner tube of the hollow-core preform is greater than or equal to 0.5 mm and less than or equal to 4 mm.

17. The method of claim 1, wherein the draw tension under which the optical fiber is drawn is between 50 g and 600 g.

18. The method of claim 1, wherein a differential core pressure is between 0.01 and 2 psig.

19. The method of claim 1, wherein the differential capillary pressure Δp_{c} is greater than or equal to 5,000 dynes/cm² and less than or equal to 100,000 dynes/cm².

20. The method of claim 1, wherein the hollow-core optical fiber is drawn in a draw furnace having hot zone ranging between 3 cm and 50 cm.
